(19) United States
(12) Patent Application Publication
(10) Pub. No.: US 2023/0339198 A1
(43) Pub. Date: Oct. 26, 2023

(54) NANOCOMPOSITE GRADIENT-INDEX VARIABLE-FOCUS OPTIC

(71) Applicant: Vadient Optics, LLC, Vashon, WA (US)

(72) Inventors: George Williams, Vashon, WA (US); John Paul Harmon, Albany, OR (US)

(21) Appl. No.: 18/341,521

(22) Filed: Jun. 26, 2023

Related U.S. Application Data
(63) Continuation-in-part of application No. 18/045,078, filed on Oct. 7, 2022.
Application No. 18/045,078 is a continuation of application No. 14/970,378, filed on Dec. 15, 2015, now Pat. No. 11,465,375.

(51) Int. Cl. B29D 11/00; G02B 3/00; G02B 1/04

(52) U.S. Cl. CPC B29D 11/00403; G02B 3/0087; G02B 1/041; B29D 11/00355; G02B 3/0081; B82Y 20/00

(57) ABSTRACT

An optic configured for variable wavefront shaping of electromagnetic radiation comprises first and second optical elements each including a solidified heterogeneous coalescence of nanocomposite material providing respective first and second complex dielectric-function gradients. The first and second optical elements are arranged in tandem along an optical axis and together provide wavefront shaping that varies in dependence on a displacement of the first optical element relative to the second optical element.

### CROSS-REFERENCE TO RELATED APPLICATIONS

This application is a continuation-in-part of U.S. patent application Ser. No. 18/045,078 filed 7 Oct. 2022 entitled NANOCOMPOSITE REFRACTIVE INDEX GRADIENT VARIABLE FOCUS OPTIC, which is a continuation of U.S. patent application Ser. No. 14/970,378 filed 15 Dec. 2015 and entitled NANOCOMPOSITE REFRACTIVE INDEX GRADIENT VARIABLE FOCUS OPTIC, now U.S. Pat. No. 11,465,375; the entirety of both patent applications is hereby incorporated herein by reference for all purposes.

### TECHNICAL FIELD

This disclosure relates generally to optical elements and more particularly to paired optical elements that, when translated relative each other, vary the phase of the wavefront incident thereon.

### SUMMARY

This disclosure is directed to composite, variable dielectric-property optics. In one aspect, a composite, gradient refractive-index optic comprises first and second optical elements each including a non-homogeneous material and having an optical function such that when arranged in tandem along the optical axis, the shape or direction of the transmitted electromagnetic wavefront varies as a function of the relative displacement between the elements.

The optical functions may include freeform, anamorphic, or non-axisymmetric optical functions, for instance. The variable dielectric-property optic may include refraction, permittivity, and permeability, which are related to one another. A gradient refractive index (GRIN) optic is one example, where a changing refractive index can change the direction of an optical wavefront. This approach applies to wavefronts beyond the visible wavelength range, extending to the infrared (IR), radio-frequency (RF), and millimeter wave (MW) domains. GRIN optics may include composite materials with particle sizes much smaller than the wavelengths to be refracted. Composite materials may include inkjet-printed nanocomposites deposited with a concentration gradient within the optical elements formed.

This Summary is provided to introduce in simplified form a selection of concepts that are further described in the Detailed Description. This Summary is not intended to represent key or essential features of the claimed subject matter, nor to limit the scope of the claimed subject matter. Neither is the claimed subject matter limited to implementations that solve any disadvantage noted in any part of this disclosure.

### BRIEF DESCRIPTION OF THE DRAWINGS

FIG. 1A is a perspective view illustrating a nanocomposite-ink gradient refractive-index with variable focus optic comprising a first optical element, a second optical element, each the optical elements comprised of a cured nanocomposite ink wherein the first and second optical element have a cubic volumetric gradient refractive-index such that when arranged in tandem along an optical axis the optical power varies based on linear translation with respect to another.

FIG. 1B is a perspective view of the variable focus optic shown in FIG. 1A wherein the first optical element and the second optical element are tandemly arranged.

FIG. 2A is a plan view of the variable focus optic as shown in FIG. 1A and FIG. 1B illustrating a neutral alignment position with an offset of zero.

FIG. 2B is a cross-section view of the neutrally aligned variable focus optic as shown in FIG. 2A, further illustrating optical ray propagation.

FIG. 2C is a plan view of the variable focus optic as shown in FIG. 1A and FIG. 1B illustrating a positive alignment position with a positive offset.

FIG. 2D is a cross-section view of the positive aligned variable focus optic as shown in FIG. 2C further illustrating optical ray propagation.

FIG. 2E is a plan view of the variable focus optic as shown in FIG. 1A and FIG. 1B illustrating a negative alignment position with a negative offset.

FIG. 2F is a cross-section view of the negative aligned variable focus optic shown in FIG. 2E further illustrating optical ray propagation.

FIG. 3 is a cross-section view of the variable focus optic further comprising an intermediate layer between the first optical element and the second optical element;

FIG. 4 is a plan view of a variable focus optic further comprising an alignment mark for rotational.

FIG. 5 is partial perspective view of the sidewall of a variable focus optic, wherein the alignment feature is scaled for a linear encoder.

FIG. 6 is a cross-section view of a variable focus optic with an alignment mark following an aspheric contour to guide post-processing.

FIG. 7 is a cross-section view of a variable focus optic, wherein the first optical element and second optical element have a cubic free form surface.

FIG. 8A is a plan view of a variable focus optic with an array of cubic volumetric refractive gradient profiles.

FIG. 8B is a perspective view of the variable focus optic with an array of cubic volumetric refractive gradient profiles as shown in FIG. 8A wherein the first optical element and the second optical element are tandemly arranged.

FIG. 9 shows aspects of an example method of manufacture of a nanocomposite ink-based optic with a complex dielectric-function gradient and variable focus.

FIG. 10 shows aspects of (a) a variable-thickness surface-figured homogeneous-index Alvarez-lens elements, and (b) an example GRIN representation of a plano-plano Alvarez-lens elements with a uniform thickness, in which the plano-plano GRIN elements are designed to have the same optical path difference (OPD) as the surface-figured homogeneous-index Alvarez-lens elements of panel (a).

FIG. 11 shows example aspects of configurations A and B of Table 1 herein, illustrating one element of a pair of opposing GRIN optical elements.

FIG. 12 shows aspects of a conjugated GRIN devices comprised of plano-piano GRIN optical elements, wherein the rotational shift of the plano-piano GRIN optical elements cause the angle of deflection of the beam to change in azimuth or elevation as a function of the relative angle of rotation between the two.

FIG. 13 shows aspects of a GRIN phase plate optical element with a refractive index distribution that implements a parabolic wedge index function across the device, such that when translated linearly relative to a complementary GRIN phase plate optical element it creates a variable cylindrical wedge function.

FIG. 14 shows aspects of an example of a GRIN phase plate with an index distribution that implements a helical phase function, wherein the index of refraction gradient changes radially as a function of the angle α.

FIG. 15 shows aspects of a GRIN phase plate optical element implemented with a refractive index profile that implements a saddle function.

FIG. 16 shows (a) aspects of an example zoom lens comprising two conjugated GRIN devices that are positioned relative to one another along the optical axis and are positioned relative to one another along the optical axis, between surface figured homogeneous index lenses; and (b), an aspect of an afocal arrangement of two conjugated GRIN devices, positioned between homogeneous index lenses, wherein the second conjugated GRIN device is positioned at the focal plane of the first conjugated GRIN device.

FIG. 17 shows aspects of an example optic configured for variable wavefront shaping of electromagnetic radiation.

FIG. 18 shows aspects of an example of a GRIN phase plate in which the complex dielectric-function gradients change in three coordinate dimensions.

FIG. 19 shows aspects of a GRIN phase plate optical element implemented with a refractive index profile that implements a cubic index function, where the GRIN phase plate optical element is designed to change the focus of a beam when translated relative to a complementary GRIN phase plate optical element.

FIG. 20 shows aspects of (a) a surface-figured optical element composed of two conjugate parts designed to provide variable optical power as a function of translation as a result of the combined surface shapes; (b) an example equivalent GRIN optic in two opposing plano-plano parts designed to modulate incident wavefronts to cause variable optical power as a function of translation of the combined GRIN profiles; and (c) an example GRIN optic in two opposing plano-plano parts designed to modulate incident wavefronts to cause deflection of an incident beam as a function of translation of the combined GRIN optical elements.

FIG. 21 shows aspects of a GRIN phase plate optical element with a refractive index distribution that implements a spiral phase function across the device.

FIG. 22 shows aspects of an example of a GRIN optical element.

FIG. 23 is a graph of example first and second volume-fraction profiles of a GRIN optic, each plotted as a function of a coordinate r.

FIG. 24 shows aspects of an example apparatus configured for additive manufacture of a GRIN optic.

### DETAILED DESCRIPTION

### I

A zoom optic or variable-focus optic has an effective focal length or power that can be manipulated to change magnification. The most prevalent type of zoom lens comprise a grouping of optical elements situated along an optical axis wherein change in effective focal length is accomplished by movement of one or more of the optical elements along the optical axis. Other systems include optical elements wherein surface curvature or shape can be altered mechanically or by some other stimulus. This disclosure relates to another approach.

This disclosure is directed to a nanocomposite refractive gradient variable focus optic. In one aspect the nanocomposite-ink refractive gradient optic with variable focus optic comprising a first optical element, a second optical element, each the optical elements comprised of a cured nanocomposite ink wherein the first and second optical element have a cubic volumetric gradient refractive-index such that when arranged in tandem along an optical axis the optical power varies based on linear translation with respect to another.

Referring now to the drawings, wherein like components are designated by like reference numerals. Figures are characterized by mutually perpendicular axis in Cartesian coordinates allow other coordinate systems to be used. Methods of manufacture and various embodiments of the disclosure are described further hereinafter.

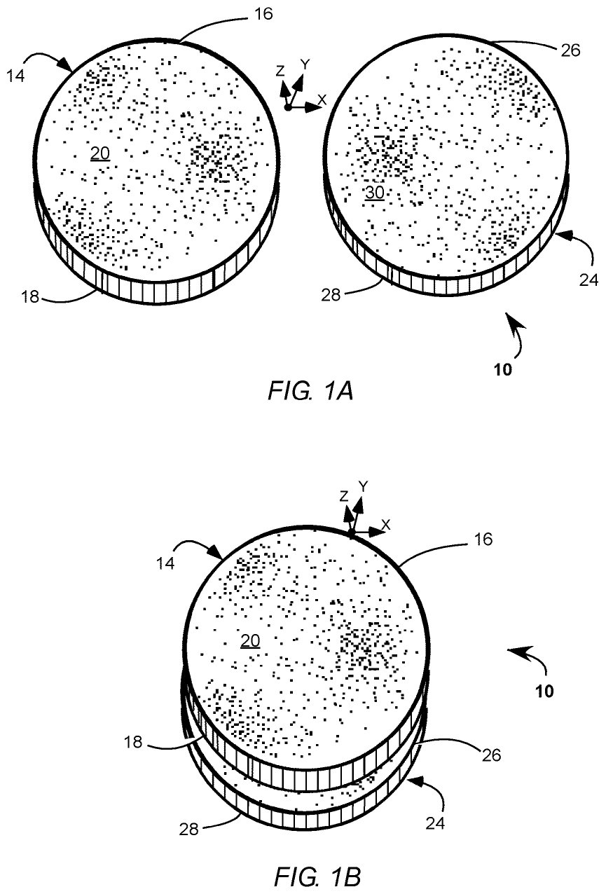

Referring to FIG. 1A and FIG. 1B, a nanocomposite-ink gradient refractive-index optic with variable focus optic 10, also referred herein as variable focus optic, comprises two optical elements. The optical elements are normally situated in tandem arrangement as that shown in FIG. 1B, drawn side-by-side for illustrative purposes in FIG. 1A. Variable focus optic 10 has a first optic element 14 with a first surface 16, a second surface 18, and a cured nanocomposite ink 20 within and a second optic element 24 with a first surface 26 and a second surface 28 and a cured nanocomposite ink 30 are aligned in tandem on an optical-axis 19. Here, the first and the second surface of each of the optical elements are planar, although the surfaces can be figured into any curvature including symmetric positive, symmetric negative, cylindrical, and freeform shapes. The cured nanocomposite ink comprises of an organic matrix with a nanoparticle dispersed within.

The cubic volumetric gradient refractive-index is achieved by depositing and curing one or more types of the nanocomposite inks. The optical properties of the organic matrix, the nanoparticles, and the nanoparticle concentration determine the refractive-index in any particular area. The cured nanocomposite inks comprising the nanoparticles dispersed within the organic matrix can be composed of various materials. The organic matrix of the nanocomposite ink is a curable resin optically transmissive for those wavelengths of the optical elements intended use. Within this disclosure, nanocomposite inks can also include the organic matrix without nanoparticles, also referred to as neat organic matrix. The organic matrix can be cured by photo exposure, thermal processes chemical process, and combinations thereof. Non-limiting examples of organic-matrix materials include polyacrylate, hexanediol diacrylate (HDODA), polymethyl methacrylate (PMMA), diethylene glycol diacrylate (DEGDA), neopentyl glycol diacrylate (NPGDA), tricyclododecane dimethanol diacrylate (TCDDMDA), bisphenol A novolac epoxy dissolved in organic solvent (SU-8), and other such materials.

The nanoparticles dispersed within the organic matrix can be any material or nanostructure that is sufficiently small to not scatter light of wavelengths intended to be used with the optical element. The nanoparticles can comprise one or more metal, dielectric, semiconductor, or organic materials.

Nonlimiting examples of nanoparticles include beryllium oxide (BeO), barium titanate (BaTiO₃), aluminum oxide (Al₂O₃), silicon carbide (SiC), zinc oxide (ZnO), silicon dioxide (SiO₂), hollow silicon dioxide nanospheres (hollow SiO₂) zinc sulfide (ZnS), zirconium oxide (ZrO₂), yttrium orthovanadate (YVO4), titanium oxide (TiO₂), copper sulfide (CuS₂), cadmium selenide (CdSe), lead sulfide (PbS), tellurium oxide (TeO₂), magnesium oxide (MgO), aluminum nitride (AlN), LaF₃, GaSbO, nano-diamond, ThF₄, HfO₂—Y₂O₃, Yb₂O₃, Dy₂O₃, ZrO₂—Y₂O₃, Si₃N₄, Y₂O₃, KBr, Ta₂O₅, HfO₂, AlGaP, SiGe, GaAs, Au, LiF, and molybdenum disulfide (MoS₂) including those with core, core-shell, core-shell-ligand, and hollow architectures.

The nanocomposite inks can be formulated by the nanoparticles type or type, the organic matrix, organic-matrix type, concentration of nanoparticles, and combinations thereof. The refractive-index of the nanocomposite inks is influenced by the formulation. An approximation of the optical properties can be calculated based on the linear summation of the optical properties calculated for the proportionate volume percentage of the organic-matrix materials and the optical properties calculated for the volume percentage of the nanoparticles, although direct measurement is a preferred method of determining the refractive index for any given nanocomposite-ink formation. For a nanocomposite ink with one nanoparticle type, the refractive index is given by the following equation,

n_{eff}(λ)=V%_{NP}(λ)×n_{NP}(λ)+V%_{OM}(λ)×n_{OM}(λ), (1)

where n_{eff}(λ) is the effective index of the nanocomposite ink, V %_{NP}(λ) is the percent volume of the nanoparticles, n_{NP}(λ) is the refractive-index of the nanoparticles, V %_{OM}(λ) is the percent volume of the organic matrix, and n_{OM}(λ) is the refractive-index of the organic matrix. Additional nanoparticles types can be added and percent volume and refractive-index included in the equation. For instance, nanocomposite ink with nanoparticles that have a high-index relative to the organic matrix will have a refractive-index that increases in proportion to the volume of nanoparticles relative to that matrix host material increases. Likewise, a nanocomposite ink with a low-index nanoparticle, for instance a hollow Buckminsterfullerene or a hollow nanosphere, comprised mostly of air, which has an optical refractive index (n) of n=1, results in a nanocomposite ink with a refractive index lower than the organic matrix, which decreases closer to n=1 as the percentage of nanoparticles in the composition increases.

Using one or more of nanocomposite inks, each formulated with different compositions, the deposition of droplets of various nanocomposite inks, allows solids with volumetrically varying complex dielectric functions to be fabricated, with allows the materials to exhibit first- and higher-order complex optical properties. These properties can include the index of refraction, third-order susceptibility, or other nonlinear optical effects. One method of manufacturing the optical element of this disclosure is inkjet printing, described in detail further below.

Inkjet printing the nanocomposite ink allows materials with complex optical effects to be formed that can vary throughout their volume. These effects include the first order complex refractive index and higher order nonlinear effects such as the real and imaginary parts of the third-order susceptibility and the nonlinear refractive index and absorption coefficients.

To manufacture a volumetric gradient refractive-index at least two of the nanocomposite inks must be used, although additional optical inks, including optical inks without nanoparticles. These inks can be printed individually or can be mixed during the printing process to yield optical properties that differ from that of the droplets themselves. One of the nanocomposite inks printed must have an optical index at least as low as that required by the gradient optical profile and the other nanocomposite ink must have an optical index as least as high as the highest required by the gradient optical index profile. Intermediate values can be obtained by controlled deposition techniques including nanoparticle diffusion control and advective mixing. Such printing apparatus and printing techniques are described in U.S. patent application Ser. No. 14/863,297, assigned to the assignee of this disclosure, and hereby incorporated by reference in its entirety.

One method of manufacturing the nanocomposite-ink gradient complex optical index solid includes the steps of having or providing a nanocomposite-ink printing apparatus with a nanocomposite ink comprising of an organic matrix with a nanoparticle dispersed within. Depositing and forming a first optic element having a first surface and a second surface with a cubic volumetric gradient optical index. Depositing and forming a second optic element having a first and a second surface with a cubic volumetric gradient refractive-index.

The variable focus optic can be printed separately as shown in FIG. 1A or in tandem arrangement as shown in FIG. 1B. The printing process can include additional process steps and features. For instance, additional optical elements, alignment features, and sacrificial areas can be printed. Alignment features can be deposited within the optical elements, on surfaces, and combinations thereof. For instance alignment features can be printed to aid in rotational alignment, inform post-process surface figuring, and as a guide for cleaving.

First optical element 14 and second optical element 24 have a cubic volumetric gradient refractive-index profile wherein the z-axis integrated nanocomposite-ink profile through both the first optical element and the second optical element has at least an approximate parabolic refractive-index profile. The parabolic refractive-index profile changes as a function of linear translation between first optic 14 and second optic 24. In some embodiments the parabolic profile has a symmetric change as a function of translation in the x-axis. Such embodiments have a cubic refractive-index profile described by

∫C(x,y,z)dz=Aₓx³+A_{xy}yx²+Bx²+Cxy+Dy²+Ex+Fy+G, (2)

where A, B, C, D, E, and F are constants that can be optimized to obtain a desired profile. The cubic concentration profile of the first optical element has a cubic term that is the opposite in sign of the second optical element such that the cubic term is eliminated in summation of each of the cubic concentration profiles and the summed concentration profile has a parabolic term −2Aδ(x²+y²), where offset δ is the linear offset from the optical axis of each the optical element. In other embodiments the parabolic refractive-index profile has a cylindrical power change when translated in the x-axis or the y-axis. Such embodiments have a cubic concentration profile described by:

∫C(x,y,z)dz=N_{O}(1−(Ax³+A_{y}y³+Bx²+Cxy+Dy²+Ex+Ey)), (3)

where both cubic terms are eliminated in summation. Equal spatial translation in both the x-axis and y-axis causes a symmetric power change.

The focal length of the variable power optic is inversely proportional to the offset and thickness of the optical elements although the thickness of the optical elements and spatial separation between the two optical elements must remain sufficiently thin such that the thin lens approximation remains accurate. For planar optics with approximately the same magnitude coefficients, thickness and offset of zero, the focal length is infinite and therefore the optic has zero power. For a positive offset, the power increases, for a negative offset power decreases.

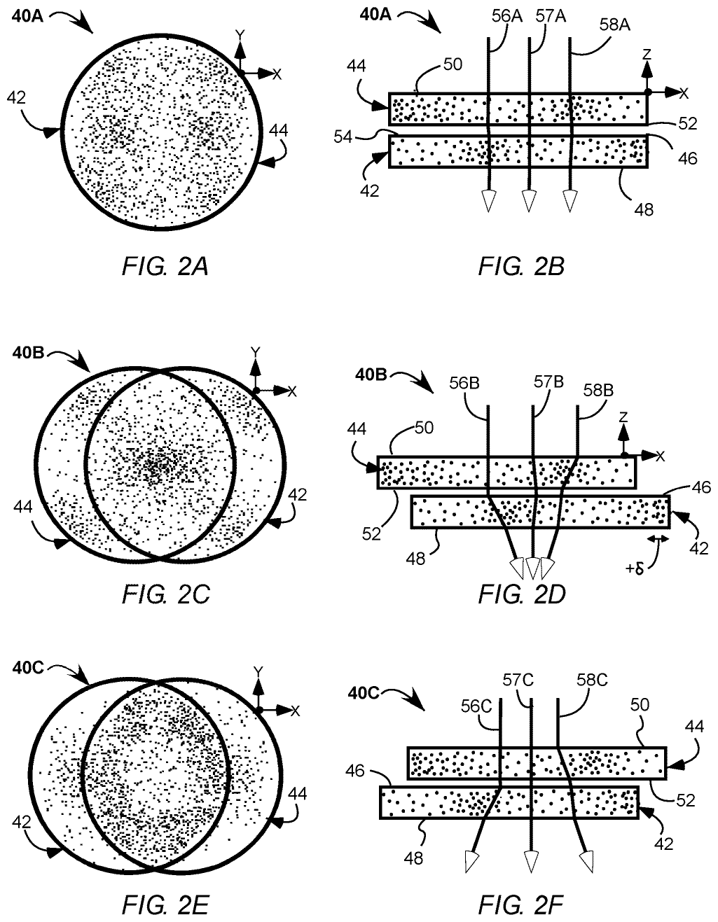

Referring to FIG. 2A and FIG. 2B, a neutrally aligned variable power optic 40A with a first optical element 42 and a second optical element 44. First optical element 42 has a first surface 46 and a second surface 48 with a cubic volumetric nanoparticle gradient refractive profile. Second-optical element 44 has a first surface 50 and a second surface 52 with a cubic volumetric nanoparticle gradient refractive profile. First optical element 42 is aligned in tandem with second optical element 44, here with no orthogonal offset. As aligned the concentration of nanoparticles as integrated along the z-axis through both the first optical element and the second optical element is constant exemplified by the uniform concentration as illustrated in FIG. 2A.

An on-axis ray 57A, a marginal ray 56A, and a marginal ray 58A propagate in parallel to neutrally aligned optical elements 42 and 44. The rays enter at an orthogonal angle to first surface 50, continuously refract through first optical element 42 exit second surface 52 into an air gap 54 at an angle oblique with the optical axis. The rays refract at first surface 46 and continuously refract through first optical element 42 such that the rays exit orthogonal to second surface 48 and parallel to the optical axis.

Referring to FIG. 2C and FIG. 2D a positively aligned variable power optic 40B has that shown in FIGS. 2A and 2B, except here, first optic 42 has a positive offset δ in relation to the origin (x=0, y=0). Aligned the positive offset the concentration of nanoparticles as integrated along the z-axis through both the first optical element and the second optical element has a positive parabolic shape exemplified by the plan view illustration shown in FIG. 2C.

An on-axis ray 57B, a marginal ray 56B, and a marginal ray 58B propagate in parallel to positively aligned optical elements 42 and 44. As before all the optical rays enter at an orthogonal angle to first surface 50. Here, optical ray 56B refracts little though second optical element 44, exits, then refracts towards the optical-axis through first optical element 42 towards the larger concentration of nanoparticles, and exits first second surface 48 converging towards a focal spot. On axis ray 57B continuously refracts through second optical element 50 in the positive x-direction, refracts through first optical element 52 in the negative x-direction towards the optical axis and exits about parallel with the optical-axis, although some parallax may occur due to the asymmetry. Marginal ray 58B refracts continuously through second optical element 44 towards the larger concentration of nanoparticles and exits second surface 52 towards first optical element 42. Marginal ray 58B refracts little through first optical element 42 and exits first surface 48 towards the focal spot.

Referring to FIG. 2E and FIG. 2F, a negatively aligned variable power optic 40C has that shown in FIGS. 2A and 2B, except here, first optic 42 has a negative offset+δ in relation to the origin (x=0, y=0). Aligned the negative offset the concentration of nanoparticles as integrated along the z-axis through both the first optical element and the second optical element has a positive parabolic shape exemplified by the plan view illustration shown in FIG. 2E.

An on-axis ray 57C, a marginal ray 56C, and a marginal ray 58C propagate in parallel to positively aligned optical elements 42 and 44. As before all the optical rays enter at an orthogonal angle to first surface 50. Here, optical ray 56C refracts little though second optical element 44, exits, then refracts away from the optical-axis through first optical element 42 towards the larger concentration of nanoparticles, here shifted away from the optical axis. Optical ray 56C exits first second surface 48 diverging from the optical-axis. On-axis ray 57C continuously refracts through second optical element 50 in the positive x-direction, refracts through first optical element 42 in the negative x-direction towards the optical axis and exits about parallel with the optical-axis, although some parallax may occur due to the asymmetry. Marginal ray 58C refracts continuously through second optical element 44 towards the larger concentration of nanoparticles, here diverging from the optical-axis, and exits second surface 52 towards first optical element 42. Marginal ray 58B refracts little through first optical element 42 and exits first surface 48 diverging from the optical-axis.

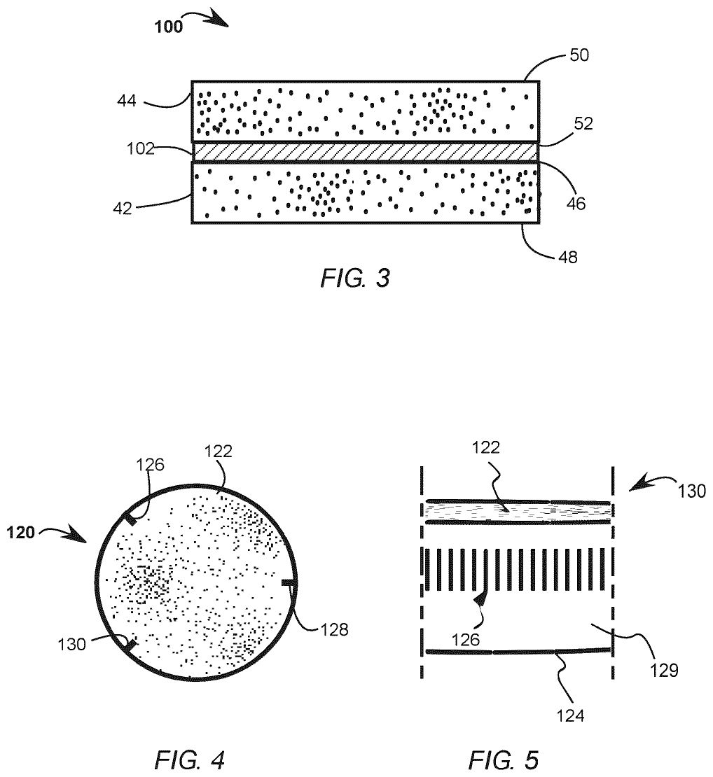

Referring to FIG. 3, a variable focus optic 100 has that shown in FIG. 1B, further comprising a sacrificial layer 102. When printed in tandem arrangement, sacrificial layer 102 can be deposited between first optical element 42 and second optical element 44. The sacrificial layer facilitates cleave between the two optical elements. Alternatively, an elastomeric layer can be deposited between the optical elements allowing movement between the two-optical elements and reducing surface refraction at facing surfaces.

Referring to FIG. 4, an optical element 120 has a first surface 122 with an alignment feature 126, alignment feature 128, and alignment feature 130. Here the alignment features are on first surface 122, distributed on the perimeter of optical element 120 to facilitate rotational alignment to another optical element.

Referring to FIG. 5, an optical element 130 is shown with a first surface 132, a second surface 124, and alignment feature 126. Here, alignment feature 126 positioned on an outer sidewall 129 are spaced scales. Various types of scales can be deposited inducing optical, magnetic, capacitive and inductive. During the printing process the scales can be deposited on the outer sidewall to pair with a sensor thereby forming an encoder for position feedback. The variable focus optic can be paired with a linear translation stage, such as a MEMS stage, and the encoder can provide direct positional feedback.

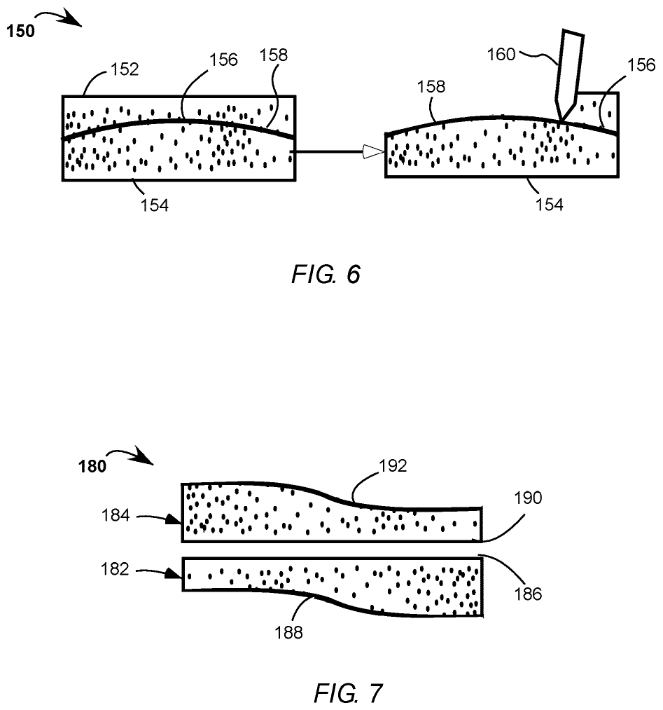

Referring to FIG. 6, an optical element in process 150 has a first surface 152, a second surface 154, and an alignment feature 156. Here alignment feature 156 is positioned with the volume of the optical element along an aspheric contour 158. Alignment feature 156 provides positional feedback to inform post-process surface figuring. For instance a single-point diamond turning head 160 can either use the alignment feature to setup a CNC tool or if equipped with optical recognition can follow alignment feature 156 to form the aspheric contour 158.

Referring to FIG. 7, an optical element 180 has a first optical element 182 and a second optical element 184 each with a cubic volumetric gradient refractive-index. Here, first optical element has a first surface 186 that is planar and a second surface 188 that has a cubic contour. Second optical element 184 has a first surface 192 that has a cubic contour and a second surface 190 that is planar.

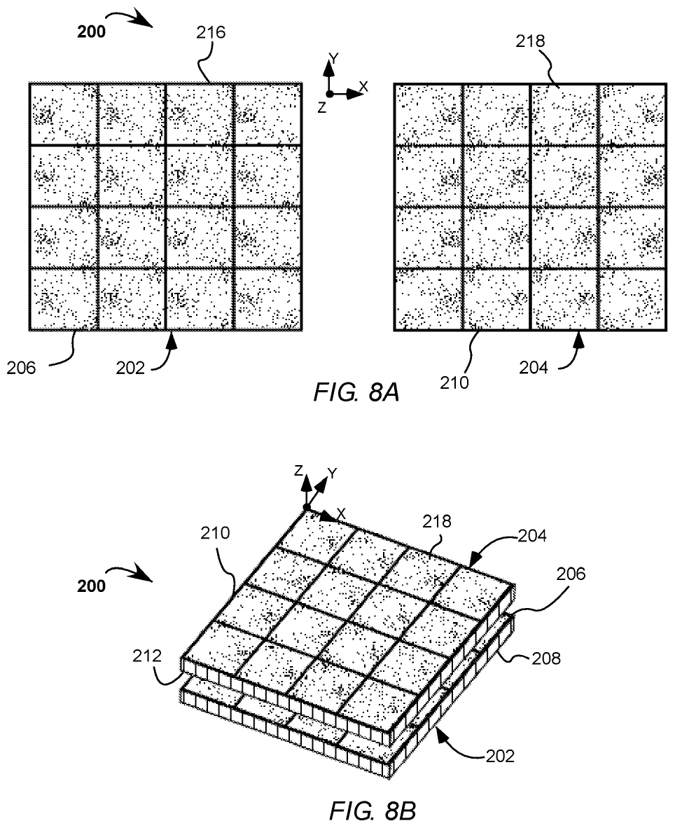

Referring to FIG. 8A and FIG. 8B, a variable focus optic with an array of cubic volumetric refractive gradient profiles has a first optical element array 202 and a second optical element array 204. First optical element array 202 has a first surface 206 and a second surface 208 with a plurality of cubic volumetric refractive gradients between. Second optical element array 204 has a first surface 210 and a second surface 212 with a plurality of cubic volumetric refractive gradients between. Here, the cubic volumetric refractive gradients is a four-by-four array.

The first optical element's cubic volumetric refractive gradients are paired with the second optical element's cubic refractive gradients wherein each pair have an optical power that varies on linear translation. By way of example, an exemplary cubic volumetric refractive gradient 216 and 218 has a power when tandemly arranged such as that shown in FIG. 8B. Each of the paired volumetric refractive gradients can have the same power or the power can vary across the array.

Here, each of the cubic volumetric refractive gradients have a square optical shape to increase the fill factor. In other embodiments the optical aperture can be circular. Carbon, metal, or other opaque inks can be used to separate isolate each of the paired cubic volumetric refractive gradients to reduce or eliminate crosstalk during linear translation. As noted above, the area between the first optical element and second optical element filled and surfaces can shaped.

Some implementations will now be summarized. The first implementation is a method of manufacturing a nanocomposite-ink gradient complex optical index optic with variable focus comprising: (a) having or providing a nanocomposite-ink printing apparatus with a nanocomposite ink comprising of an organic matrix with a nanoparticle dispersed within; (b) depositing and forming a first optic element having a first surface and a second surface with a cubic volumetric gradient optical index; and (c) depositing and forming a second optic element having a first and a second surface with a cubic volumetric gradient optical index. Here the first optical element and the second optical element each comprise a cured nanocomposite ink with an organic matrix and a nanoparticle dispersed within; and the first and the second optical element are arranged in tandem along on an optical axis have an optical power that varies based on linear translation between the first and the second optical element orthogonal to the optical axis.

The second implementation is a method according to the first implementation, wherein the first optical element and the second optical element are printed in a tandem arrangement. The third implementation is a method according to the second implementation, further comprising the step of depositing a sacrificial layer between the first optical element and the second optical element, the sacrificial layer facilitating post fabrication physical separation of the first optical element and the second optical element. The fourth implementation is a method according to the second implementation, further comprising the step of depositing an elastomeric layer between the first optical element and the second optical element. The fifth implementation is a method according to the first implementation, further comprising the step of depositing an alignment feature on the first optical element, the second optical element, or both. The sixth implementation is a method according to the fifth implementation, where the alignment features are provided to inform post-process surface figuring. The seventh implementation is a method according to the fifth implementation, wherein the alignment features are provided as a guide for cleaving, sawing, or otherwise physically separating the first optical element from the second optical element. The eighth implementation is a method according to the fifth implementation, wherein the alignment features are provided for aligning the first and the second optical element during assembly of an optical system. The ninth implementation is a method according to the first implementation, wherein the first optical element and the second optical element are composed of an array of optical elements, each composed of a cubic volumetric refractive gradient profile. The tenth implementation is a method according to the ninth implementation, wherein one or more array of optical elements are printed in square, hexagonal, or other close packed geometry chosen to eliminate the proportion of light striking a non-index modulated portion of the element.

The eleventh implementation is a nanocomposite-ink gradient refractive-index optic with variable focus comprising: a first volumetric gradient refractive-index optical element having a first surface and a second surface; and a second volumetric gradient refractive-index optical element having a first surface and a second surface, wherein the first and the second optical element are arranged in tandem along on an optical axis and have an optical power that varies based on linear translation between the first and the second optical element orthogonal to the optical axis.

The twelfth implementation is an optic according to the eleventh implementation, wherein the first and the second optical element have each have at least one planar surface. The thirteenth implementation is an optic according to the eleventh implementation, wherein the first optical element and the second optical elements are formed using a nanocomposite ink having a common organic matrix material. The fourteenth implementation is an optic according to the eleventh implementation, wherein the gradient pattern of one or more optical inks is chosen to minimize geometric aberrations from the first optical element or the second optical elements surfaces. The fifteenth implementation is an optic according to the eleventh implementation, wherein the volumetric gradient refractive-index minimizes chromatic aberration. The sixteenth implementation is an optic according to the eleventh implementation, wherein the gradient pattern is chosen to minimize geometric aberration. The seventeenth implementation is an optic according to the eleventh implementation, further comprising a means of translating the first optic, the second optic, or combinations thereof. The eighteenth implementation is an optic according to the seventeenth implementation, wherein the means of translating includes manual mechanisms, motorized mechanisms, and combinations thereof. The nineteenth implementation is an optic according to the seventeenth implementation, wherein the means of translation is a microelectromechanical system. The twentieth implementation is an optic according to the first implementation, wherein the first optical element and the second optical element are made from different nanoparticle materials to correct chromatic aberration. The twenty-first implementation is an optic according to the first implementation, further comprising an intermediary layer between the first and the second optical elements. The twenty-second implementation is an optic according to the twenty-first implementation, wherein the intermediary layer has a gradient refractive index. The twenty-second implementation is an optic according to the twenty-first implementation, wherein the intermediary layer corrects chromatic aberration.

From the description herein one skilled in the art can manufacture the disclosed apparatus and practice the disclosed methods. While this disclosure has been described in terms of particular embodiments and examples, other embodiments and examples can be implemented without departing from the intended spirit or scope. This disclosure is not limited to the illustrated embodiments but only by the claims appended hereto.

### II

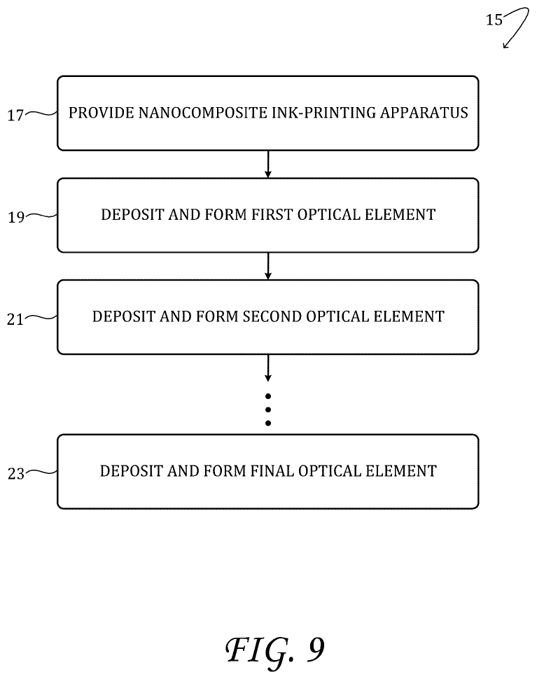

FIG. 9 shows aspects of an example method 15 of manufacture of a nanocomposite ink-based optic with a complex dielectric-function gradient and variable focus. In some examples the complex optical index is a freeform function with no axis of symmetry.

At 17 of method 15 is provided a nanocomposite-ink printing apparatus with a nanocomposite ink including an organic matrix with a nanoparticle dispersed within the organic matrix. At 19 a first optical element having a first surface and a second surface is deposited and formed. The first optical element has a gradient optical index between the first and second surfaces. At 21 a second optical element having a third surface and a fourth surface is deposited and formed. The second optical element has a gradient optical index between the third and fourth surfaces. In some examples, here and/or in step 19 above, one or more layers of deposited materials may be cured before additional layers are deposited.

In method 15 the first optical element and the second optical element each comprise a cured nanocomposite ink with an organic matrix and a nanoparticle dispersed within the organic matrix. The first and the second optical elements are arranged in tandem along on an optical axis and have an optical power that varies according to a translation between the first and second optical elements. The translation can be a circular translation orthogonal to the optical axis, in some examples. In some examples the optical axis is not necessarily perpendicular to the first optical element. In other examples the optical axis may be perpendicular to the first optical element.

At optional step 23, a third, fourth optical element, etc., may be deposited and formed by analogous processing until the final desired optical element is deposited and formed. In some examples, a third optical element is configured to cause a focal point created by the first and second optical elements to be minimized over a range of translations. In some examples, a third optical element is configured to co-locate an optical axis of the first optical element to an optical axis of the second optical element over an operating range of the translation. In method 15 the nanocomposite ink of the first optical element and the nanocomposite ink of the second optical element may be selected such that a slope of refractive index with respect to wavelength of a highest average refractive index nanocomposite ink and slope with respect to wavelength of a lowest average refractive index ink are parallel to 1% or better.

‘Freeforms’, as used herein, are optical shapes or optical surfaces designed with little or no symmetry. The added degrees of freedom afforded by freeforms makes them useful for implementing non-radially symmetric phase plates—e.g., for off-axis optical systems where axial symmetry is broken. Interest in freeform optics is driven in part by potential applications in near-eye displays and compact optical systems for medical, military, and mobile imaging, as well as illumination devices with constraints on size and weight.

Cubic-phase optical elements are freeforms of particular interest. Cubic lenses have been shown to exhibit increased depth of focus. A variant of cubic-phase optics is a focus-correcting lens called an ‘Alvarez’, ‘Lohmann’, or ‘Alvarez-Lohmann’ lens. Despite its straightforward operating principle, the Alvarez-Lohmann lens can be impractical to implement due to the aberrated optical performance of conventionally manufactured optical elements. In particular, the manufacture and metrology of transmissive cubic surfaces with the necessary precision remains a time-consuming and often expensive process. Moreover, as existing refractive freeforms are made using homogeneous materials, complex chromatic aberrations result from the dispersion introduced at their shaped surfaces.

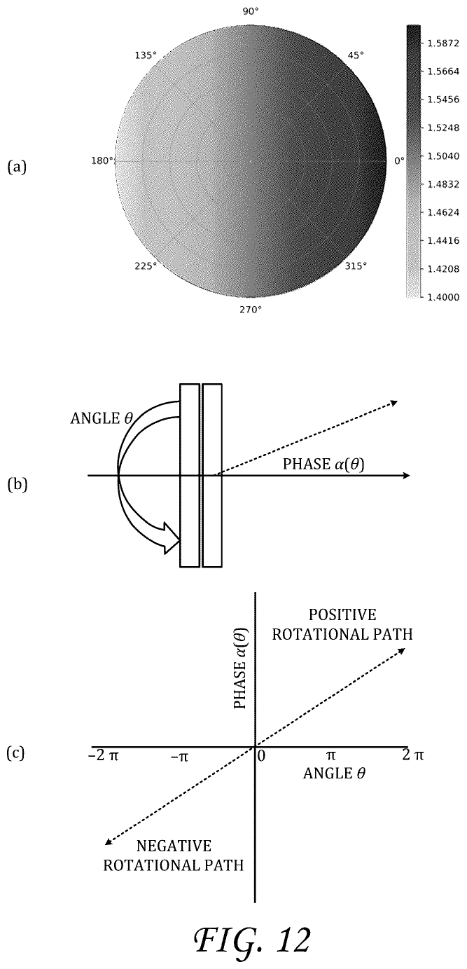

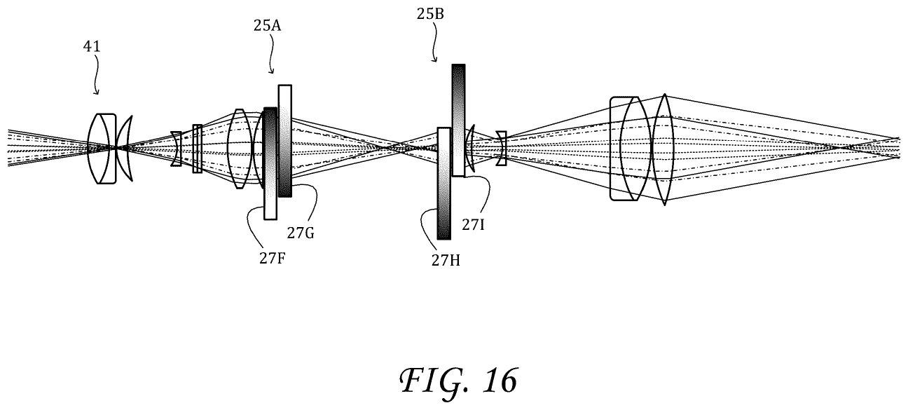

In U.S. patent application Ser. No. 14/970,378 (incorporated by reference herein for all purposes), Vadient described a gradient refractive-index optic fabricated via inkjet printing of nanocomposite materials, where nanocomposite optical elements are translated relative to one another, in a direction orthogonal to the optical axis, to change the focus. In the present disclosure, the nanocomposite optical elements are generalized to include a broader class of optical elements, where the displacements (between and among the optical elements) may be rotational as well as translational, and where the combined optical functions extend beyond optical power. Furthermore, pairs of optics of this kind may be included in an optical system to allow for cascaded optical effects such as zoom lenses (FIG. 16), or beam scanning (FIG. 12). In some examples the devices may be optimized for the part of the electromagnetic spectrum other than visible by forming permittivity or permeability index gradients. More general freeform gradient-index (GRIN) optics, in sum, offer a method of addressing the limitations of the conventional Alvarez-Lohmann approach and providing novel and non-obvious extensions directed to specific applications.

GRIN offers added degrees of freedom in the form of dimensionally varying index gradients, which may be used to reduce the size and weight of optical systems. However, confined by the available fabrication processes, GRIN-lens configurations have historically been limited to shallow, radially-symmetric index gradient profiles and to optics of relatively small size. Further, the dispersion properties of the GRIN structures have been limited by process-compatible materials. Recent advancements in the manufacturing of gradient-index (GRIN) media now make possible refractive-index distributions that can vary arbitrarily in up to three spatial dimensions, n(x, y, z).

Additive manufacture of optics has also been explored. One attribute of additive manufacture is that designs can be readily fabricated, on demand, directly from software design tools, eliminating the cost and lead times associated with manufacturing conventional freeform optics. It has recently been demonstrated that drop-on-demand, inkjet-print, additive manufacture can be used to create volumetric index gradients within an optical element. In addition to enabling fabrication of radially-symmetric spherical GRIN elements, inkjet-print manufacture enables fabrication of complex, radially symmetric, aspheric index gradients, as well as three-dimensional (3D) aspheric index gradients, where the high-order gradient profiles vary axially as function of position on the optical axis. Inkjet-print manufacture is also well-suited for manufacturing freeform index gradients.

In addition to these advantages, freeform GRIN optics offer a method of transforming optical phase. In plano-plano freeform GRIN phase plates, the refractive index gradient controls optical path differences (OPD), as opposed to the summation of figure thicknesses (where the OPD is controlled by the shapes of the homogeneous freeforms). While there are similarities between freeform GRIN and freeform surfaces, a distinct benefit of a plane-parallel freeform GRIN is that it provides degrees of freedom in three dimensions, n(x, y, z), whereas freeform surfaces provide degrees of freedom in only two dimensions, z(x, y). Also, with plane-parallel freeform GRIN, pairs of devices can be brought into closer proximity to one another, such that the pair better represents a ‘thin lens’ approximation. With 3D freeform GRIN optics, it is possible to implement arbitrary volumetric gradient profiles in which there are no axes of symmetry. The ability to create polynomial terms with longitudinal (i.e., z direction) variations in the gradient index profiles provides extra degrees of freedom not available with surface-figured freeforms. This can be used to correct for axis deviation, reduce aberrations, accommodate non-paraxial rays, and otherwise improve the performance of an Alvarez Lohmann-type lens. To maximize the degrees of freedom, it is possible to polish of machine surface figures on 3D freeform GRIN optical materials, thereby combining both approaches.

Significantly, the ability to engineer multiple nanocomposite optical materials using multi-constituent blends, and to then mix the multiple multiple-constituent optical feedstocks when print composing substrates, makes it possible to independently specify the index gradient and the dispersion of additively manufactured GRIN optical materials, allowing for fabrication of achromatic singlet lenses and achromatic freeform refractive optics.

Several of the degrees of freedom afforded by the inkjet-print additive manufacture of freeform GRIN lenses are demonstrated in the optimization, fabrication, and metrology of planar Alvarez-Lohmann lenses, demonstrated and environmentally tested for used in accommodating vision in respiratory masks. In particular, the Alvarez-Lohmann class of lenses offers a method of performing positive and negative diopter adjustments for vision accommodation in respirator masks.

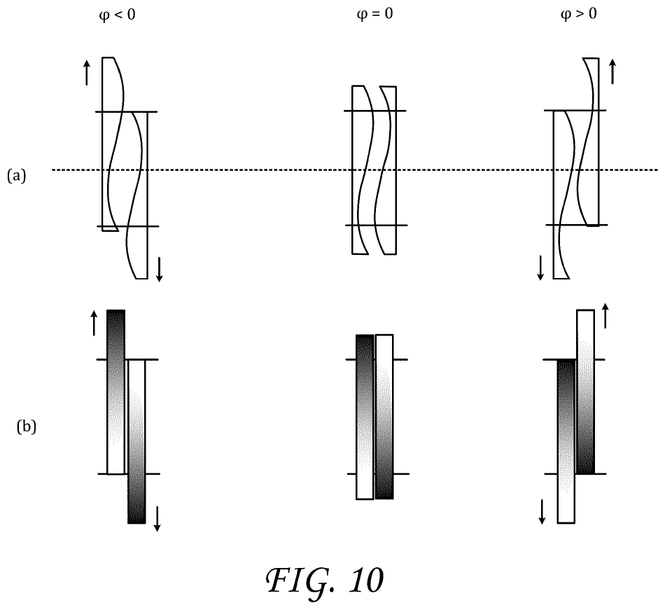

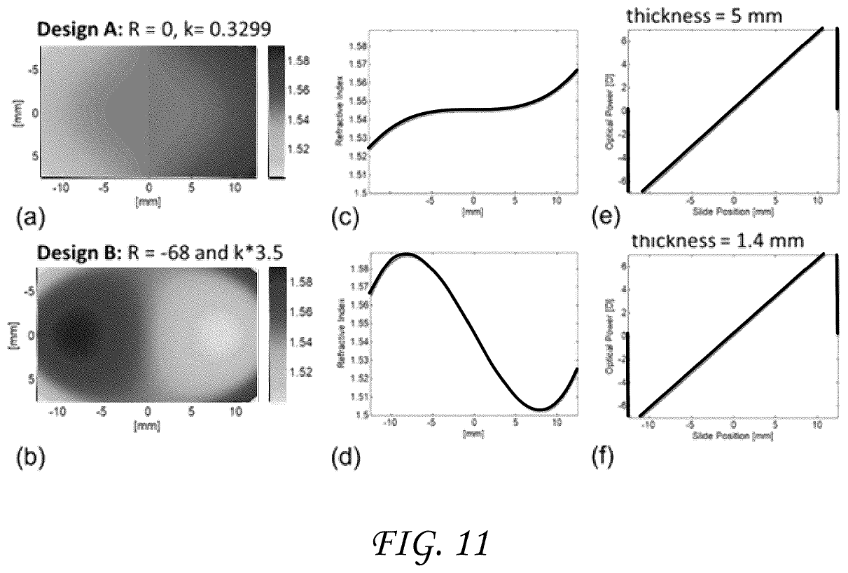

As shown by schematic example in FIG. 10, the Alvarez-Lohmann lens is a composite lens comprising two, spatially separate variable phase plate elements that, combined, make an effective lens. Panel (a) of FIG. 10 provides a schematic illustration of a common implementation of an Alvarez-Lohmann lens, with variable-thickness, surface-figured Alvarez-lens elements. In its most common implementation both lens components are plano-freeform elements with surface geometries described by a cubic polynomial equation; the first element features the negative function of the second f₁(x, y)=−f₂(x, y). With translation between the upper and lower parts of the device, the surface functions produce quadratic wavefront changes.

In a traditional Alvarez-Lohmann lens, the two variable phase plates are aligned along the optical axis, with the cubic surfaces inverted with respect to each other. When laterally aligned, the effective cumulative thickness introduces a phase delay proportional to the combined thickness of the shaped elements. The structure is designed such that at one value of lateral shift between the two parts, δ=δ₀, the device acts as a neutral optical element that does not change the wavefront of a propagating plane wave, owing to the cancellation of the cumulative phase delays introduced by the surface profiles of one element by those of other element. Thus, the system has an infinite focal length. The optical power of the device changes, however, proportionally with the lateral shift S. In performing a transverse shift of the surfaces relative to one another there is no longer perfect cancellation of the variable phase delays of the two elements. In this case, the component can be described by a phase function distribution corresponding to a simple delay on the incident illuminating wavefront, which is proportional to the effective thickness of the composite surfaces. The differential of the two cubic profiles results in a composite surface with a spherical thickness variation inducing a quadratic variation in the wavefront, such that depending on the direction of the shift, the composite thickness is equivalent to a converging or diverging lens of a certain focal length.

Alvarez and similarly Lohmann used this approach to generate varifocal lenses. The difference between Alvarez and Lohmann lens functions is the shape of the cubic surface; the relation between the Alvarez and the Lohmann descriptions is a 45-degree rotation and a scale factor of √2. In these designs, each lens has a cubic-type surface profile, which may be represented by:

z₁(x,y)=A(x³/3+xy²)+Fx+E, (4)

z₂(x,y)=−A(x³/3+xy²)−Fx+E, (5)

where x and y are in-plane transverse coordinates normal to z, representing position, and A, D, and E are design variables.

While their values can highly influence wavefront error, the F and E coefficients have no direct effect on the focal length. The coefficient E is a constant representing the lens element thickness at δ₀; it can be adjusted to reduce overall lens thickness. Although a finite gap is used to prevent collisions between the surfaces as they are shifted, assuming that there is no gap between the elements, when aligned at δ₀, the combined thickness of the two-element system is z=z₁+z₂=2 E, the equivalent of a parallel plate. Meanwhile, the coefficient F defines the tilt term of the freeform surface that affects the slope of the prism along the x direction of the cubic profile; it may be used as a compensating term to reduce the effects on sag that result from increasing the coefficient A. The coefficient A is the area scale that represents the rate of lens power variation with lens movement in the x direction.

Working within the thin-lens and paraxial approximations, one can vary the focal length of the composite pair by transversely shifting the plates relative to one another. The optical power varies linearly with δ, and both positive and negative power can be obtained by altering the direction of shear (i.e., the sign of δ). When the first element moves a displacement δ and the second moves −δ along the x direction, the combined thickness, z, has a parabolic term −2 A δ(x²+y²). The parabolic term is equivalent to a standard axially symmetric constant curvature term. For a determined lateral displacement range, the value of A affects the sag and curvature of the object-conjugate plates. The effective sag of the composite-surfaced pair gives rise to a focal point. In order to relate the spherical profile to focal length, a first-order paraxial approximation is assumed. From the sag equation of a surface, the radius of curvature, r, is given by:

R=4rδ. (6)

The effective focal length, f, of the combination, can then be calculated as

f=[4Aδ(n−1)]⁻¹, (7)

where n is the refractive index of the lens material. The refractive index contributes to the optical path difference, and this generally forces both components to be the same material if they are identical cubic surfaces. However, if both the coefficient A and n are changed proportionally, it is possible to maintain purely quadratic phase variations.

The performance limitations of prior Alvarez-Lohmann lens implementations stem from the deviation of practically manufactured lenses from their ‘thin-lens’ approximations, exacerbated by the air gap between the pair. A ‘thin-lens’ approximation allows the Alvarez-Lohmann lens to be represented by two cubic functions superimposed on top of one another, such that the coordinates at which the ray of light exits the first element and the coordinates at which it intersects the second element are the same. However, if the phase plates have a finite thickness and are separated—as is the case with homogeneous index surfaces—there can be a significant difference in the ray coordinates relative to the theoretical, causing Alvarez-Lohmann lens implementations to deviate significantly from ideal performance.

To obtain a large range of lens powers with minimal lateral translation, the value of A needs to be large, which, in turn, increases the lens sag. This causes the lenses to be increasingly thick away from the optical center. Obtaining a large optical power adjustment range in a compact configuration is also challenging. The change in optical power is proportional to the product of A and the lateral displacement, δ; so, for a compact implementation, δₘₐₓ is made small, which requires that A be large. However, increasing the value of A increases curvature, which in turn increases the sag and causes larger amounts of aberrations from the combined elements. Since the elements are non-rotationally symmetric freeforms, aberrations specific to off-axis propagation, including coma and astigmatism may also degrade performance.

Higher-order surface terms may be used to partially compensate for these aberrations; however, realizing precise high-order freeform surfaces is constrained by existing process limitations, and the correction is difficult to maintain throughout the power range. Moreover, as prior Alvarez-Lohmann lenses have been realized using homogeneous optical media (e.g., glass or plastics), chromatic aberrations present a genuine limitation. Combined with the non-superposition of the dual optical functions resulting from lens thickness, optical axis dislocation, and non-paraxial behavior of gaze angles, practical Alvarez-Lohmann lens implementations deviate from their ideals.

### IV

To address these issues and to provide other advantages, this disclosure presents a custom additive manufacture technology platform, ‘Variable Index of Refractive Gradient Optics’ (VIRGO™), which uses inkjet-printhead deposition of specific compositions of optical nanocomposite feedstock.

The properties of the printable primary ‘optical ink’ feedstocks play an important role in inkjet-constructed optical elements. The nanocomposite optical feedstocks are formulated by embedding one, or more, non-scattering organic or ceramic nanoparticles in one or more low-viscosity, optical-grade, photocurable monomers. Each nanoparticle is small (e.g., <˜10 nm, less than 1/30^{th} the wavelength of light passing through the optic) and is chemically coated to eliminate agglomeration, such that Rayleigh and Mie scattering are insignificant. The optical inks are formulated with the rheological properties necessary for reliable inkjet printhead deposition.

At minimum, using inkjet print fabrication, two optical inks are used to create a GRIN element, a ‘high index’ optical ink, n_{high}, and a ‘low index’ optical ink, mow. The difference in the index values of the two primary inks is the refractive index contrast, Δn. A unique feature of multi-constituent nanocomposite optical inks is that it is possible to precisely tailor the refractive index spectra of each optical ink relative to the other(s), to control primary and secondary color. The refractive-index spectral properties of the primary optical inks are a linear function of the volume fraction of the constituent properties of the inks. The dispersion of homogeneous materials over the ‘d;F;C’ spectrum is commonly characterized by the Abbe number, v, and partial dispersion, P, as

v=(n_{d}−1)/(N_{F}−n_{C}), (8)

P_{d,F}=(n_{F}−n_{d})/(n_{F}−n_{C}). (9)

For homogeneous materials with normal dispersion, v is always positive and the value of P is around 0.7 and is bounded between zero and one. The partial dispersion values of optical materials strongly trend linearly with their dispersion values.

For GRIN optics, the GRIN Abbe number (v_{GRIN}) and partial dispersion (P_{d, F GRIN}) are defined as

v_{GRIN}=(Δn_{d})/Δn_{F}−Δn_{C}) (10)

P_{d,F_GRIN}=(Δn_{F}−Δn_{d})/(Δn_{F}−Δn_{C}), (11)

so their values are no longer constrained. Defined by the difference in the refractive-index spectra of the high- and low-index primary optical inks used to print the gradients, the index gradients can have positive, zero, or negative v_{GRIN} values, and when more than three constituents are used to synthesize the feedstock, the dispersion can be defined independently from the index gradient.

Independent control of dispersion relative to the index gradient allows for achromatic singlet GRIN lenses to be fabricated. For example, even for a binary primary optical ink pair, if the slope of the high-index optical ink, n_{F}(high)−n_{C}(high), is matched to the slope of the low-index optical ink, n_{F}(low)−n_{C}(low), then Δn_{F}=Δn_{c} and the GRIN lens is achromatic. Moreover, by introducing sufficient additional constituents into the feedstock composition, it is possible to relax the dependence of the P_{GRIN} values relative to the V_{GRIN} values, making possible a wide range of anomalous partial dispersion GRIN materials not available in standard glass or plastic materials. Achieving dispersion and partial-dispersion values independent of the index gradient is desirable for freeform refractive optical elements, due to the complexity of dispersion attributable to freeform surfaces and gradient index functions.

Increasing the number of primary optical inks expands the degrees of freedom. The number of primary optical inks that can be printed concurrently is limited by the number of available printheads. For the simple case of a binary ink set, at least two printheads are required. Constructing each layer of the refractive index gradient requires separate bitmaps for each printhead. For each pass of the printhead over the substrate, the bitmaps define the drop density patterns of each primary optical ink.

Using inkjet print deposition, ‘print composition’ is used to define the intermediate refractive index values of the gradient profiles. With spatial droplet concentrations defined by the bitmaps, local mixing and inter-diffusion of the co-deposited primary optical inks causes the spatial localities to assume refractive index spectra that are the weighted average of the spectral properties of the constituent inks. A simple binary linear composition model allows the substrate index value to be approximated at each wavelength as a function of two primary optical inks, n_{low}(λ) and n_{high}(λ), as

n(x,y,λ)=C(x,y)_{low}n_{low}(λ)+C(x,y)_{high}n_{high}(λ)=(1−C(x,y)_{high})n_{low}(λ)+C(x,y)_{high}n_{high}(λ)=n_{low}(λ)+C(x,y)_{high}Δn(λ), (12)

where C(x, y)_{low} and C(x, y)_{high} are the local volume concentrations of the primary optical inks defined by index n_{low} and index n_{high}, respectively, at location (x, y), and Δn(λ)=n_{high}(λ)−n_{low}(λ).

In the graphics-print industry, halftoning algorithms are used to determine the placement of the optical ink droplets such that the reflective properties of the substrate create grayscale images, using only black droplets. To create refractive gradient index profile bitmaps using optical ink pairs, a comparable process is used. To accommodate three-dimensional refractive index volumes (i.e., n(x, y, z)), the halftoning algorithms quantize the refractive index profile designs in three dimensions. The residuals from quantization are distributed to neighboring pixels that have not yet been processed. This method can also be extended to three-level or multi-level halftoning, so that several primary inks can be printed concurrently. Printing multiple inks reduces the levels of quantization, allowing for more precise control over gradient index patterns. Concurrent printing of multiple inks also provides degrees of freedom for controlling dispersion and secondary color.

The stack of print maps, one for each printhead each layer, are uploaded to the printer when fabricating the optic. Using industrial printers, the drop placement of the optical inks can be controlled to better than one micron precision, but after inter-diffusion of the concentrations of optical inks and polymerization, it is possible to fabricate complex sub-wavelength smooth gradient profiles that precisely match the design intent.

Planar freeform-GRIN elements can be printed with better than λ_{632 nm}/6 flat surfaces, without post-processing. Due to the benefits of the inter-dispersed ceramic nanoparticles that are tightly crosslinked within the polymer matrix, the nanocomposite optical materials are sufficiently strong and hard that, using industry standard processes, the surfaces may be polished or shaped to high precision industry standards. The nanocomposite materials are also non-hydroscopic and have lower temperature sensitivity than plastic materials.

### V

Inkjet printing of nanocomposite GRIN materials allows for performance optimization of Alvarez Lohmann-type lenses not available with surface-shaped homogeneous materials. Panel (b) of FIG. 10 shows an example GRIN representation of a plano-piano Alvarez-lens elements with a uniform thickness, in which the plano-piano GRIN elements are designed to have the same optical path difference (OPD) as the surface-figured homogeneous-index Alvarez-lens elements of panel (a). In a plano-piano freeform GRIN Alvarez-Lohmann lens, optical power is generated in a manner analogous to that of surface-figured homogeneous index elements. The OPD is generated across the GRIN phase plates not by summing the thicknesses attributable to the surface shapes of each element, however, but by controlling Δn and the element thickness t.

Assuming no variation of the refractive index perpendicular to the optical (i.e., z) axis, the generally cubic Alvarez-Lohmann phase profiles may be represented for GRIN implementations as:

n₁(x,y)=n₀₀+k(x³/3+xy²+Rx+E), (13)

n₂(x,y)=n₀₀−k(x³/3+xy²−Rx+E), (14)

where nᵢ(x, y) is the refractive index at point x, y on the lens, n₀₀ is the base index (value of the lowest index optical ink), the index profile coefficient k is a scaling factor that describes the magnitude of the refractive index term, the coefficient R is a field constant that describes the tilt term, and E is a scalar constant. These equations do not take into account any axial (z-direction) variations of the refractive-index profiles. However, the ability to change the gradient profiles expressed in eqs 13 and 14, by adding higher order polynomial terms that vary along the axial dimension, or adding aberration or performance enhancing optical functions, allows for the devices to be optimized for specific applications. For example, aberrations can be corrected, axis-offsets may be accommodated, off axis implementations are made possible, profiles can be optimized for gaze angles, and the profiles can compensate for offsets in magnification.

The similarity between eqs 4 and 5 and eqs 13 and 14 is apparent. The index profile coefficient k of eq 13 is equivalent to coefficient A of eq 4, used to describe the magnitude of lens-power variation for a surface-figured Alvarez-Lohmann lens. The coefficient R of eq 13, when scaled by the coefficient k (i.e., R/k) is functionally equivalent to coefficient F of eq 4, which governs the amount by which the polynomial functions are tilted. The similarity shows that the OPD determines the optical functions, and that there is a GRIN profile that can be derived for freeform surface profiles that allow GRIN analogs of ‘Alvarez-Lohmann’ type elements to be realized.

For a thin Alvarez-Lohmann component, the variation in OPD within the clear aperture of a single thin plano-plano lens plate, is given by:

OPD(x,y)=t[n(x,y)−n₀₀], (15)

where n₀₀ is the base refractive index value at which point OPD=0. The OPD of the combined elements is obtained by summing the index maps of eq 14, calculated with x varied with a positive and negative translational shift, in the z-direction±δ, relative to one another other, with a combined thickness of 2 t.

### VI

Naturally, the eye is a compound optical system, and an eye-lens-object optical system is set according to the wearer's visual performance and the characteristic of the lens assembly, as defined by dioptric power, astigmatism, and visual axis. For use in vision-corrective optics, the optical power of the Alvarez-Lohmann lens is modeled as though it were a radial lens fitting within the eyebox, with a focal length, f_{GRIN}:

f_{GRIN}=r²/(2tΔn), (16)

where Δn is the maximum index change across the eyebox, r is half the width of the eyebox, t is the thickness of the lens. The focal length is inversely proportional to diopters according to the relation D=1000/f_{GRIN}; thus:

D=(2000tΔn)/r². (17)

There are different combinations of t and Δn that grant the same power variation, and increasing either t or Δn enables larger values of the coefficient k, which enables high optical power to be achieved. However, Δn is practically limited by the properties of the available optical feedstock. With materials optimized for inkjet printing, which are constrained by the printhead-compatible rheological properties of the optical inks, Δn is typically between 0.06 and 0.12 in the visible wavelength range. For some industrial printheads, Δn values larger than 0.28 are possible.

Within the constraints of the application, the Alvarez-Lohmann cubic profiles may be optimized by varying the coefficients k and R, which may be assumed equal and opposite for each element. To select the ideal scaling factor k and field constant, the contributions of the Seidel aberrations and the overall RMS wavefront error may be evaluated at various positions in the eyebox.

TABLE 1
Selected GRIN Alvarez-Lohmann lens configurations.

| Lens Design | A | B | C | D | E | F | G | H | I |
|---|---|---|---|---|---|---|---|---|---|
| Index rate constant (10⁻⁴), k | 0.329 | 1.152 | 3.33 | 2.97 | 1.71 | 1.71 | 0.987 | 3.33 | 3.41 |
| Field tilt constant, R | 0 | 68 | 25 | 25 | 38 | 38 | 56 | 38 | 38 |
| R/k (10⁴) | 0.00 | 59.03 | 7.51 | 8.42 | 22.22 | 22.22 | 56.74 | 7.51 | 11.14 |
| Optical power (±D) | 5 | 5 | 5 | 5 | 5 | 5 | 5 | 5 | 9 |
| GRIN Δn | 0.089 | 0.089 | 0.06 | 0.06 | 0.06 | 0.06 | 0.06 | 0.06 | 0.12 |
| Thickness (z, mm) | 5 | 1.40 | 0.5 | 0.84 | 0.98 | 1.22 | 1.26 | 1.4 | 1.1 |
| Lateral Shift (Δδ, mm) | 7.5 | 7.5 | 7.5 | 5 | 7.5 | 6 | 10 | 7.5 | 6 |
| Lens Width (mm) | 25 | 25 | 20 | 20 | 25 | 25 | 30 | 25 | 25 |
| Eyebox width (mm) | 10 | 10 | 5 | 10 | 10 | 10 | 10 | 11 | 11 |
| Width/Eyebox Ratio | 2.5 | 2.5 | 4 | 2 | 2.5 | 2.5 | 3 | 2.5 | 2.5 |
| WFE - eyebox center | 0.0044 | 0.0012 | 0.0004 | 0.0011 | 0.0009 | 0.0014 | 0.0008 | 0.0010 | 0.0039 |
| WFE-eyebox edge x (left) | 0.0202 | 0.0068 | 0.0009 | 0.0067 | 0.0084 | 0.0076 | 0.0049 | 0.0030 | 0.0254 |
| WFE-eyebox edge y (top) | 0.0405 | 0.0127 | 0.0008 | 0.0065 | 0.0051 | 0.0077 | 0.0049 | 0.0130 | 0.0234 |

A summary of nine different configurations selected from a configuration-trade study is shown in Table 1. FIG. 11 shows example aspects of configurations A and B of Table 1 herein, illustrating one element of a pair of opposing GRIN optical elements. Panels (a) and (b) show gradient-index maps; panels (c) and (d) show x-axis cross sections of the gradient index through the center; and panels (e) and (f) show the optical power as a function of lateral translation when one element is translated against a duplicate of itself inverted in they direction. The examples show how the variables of the Alvarez-Lohmann lens may be changed to change the optical performance: in this case optical power. Configuration B shows an example of how the Alvarez-Lohmann function can be tilted relative to the optical axis so that the full value range of index values can be used and the optical power can be increased in a thinner configuration.

Configurations A and B are implemented with Δn=0.089 and differ from each other by the value of coefficient R, which describes the tilt term. The thickness of the elements is minimized when Δn is maximized and the tilt term is optimized. Configuration A was implemented without tilt of the polynomial function and as a result was 3.57 times thicker than Configuration B. As shown in Table 1, due to it being thinner, Configuration B had lower WFE across the eyebox than did Configuration A.

Further with respect to FIG. 11, the equation for the cubic Alvarez lens is

z(x,y)=(ax³+by³+cx²y+dxy²+ex²+fy²+gx+by+i), (18)

where z(x, y) is the surface height of the lens at position (x, y), and a, b, c, d, e, f, g, h, ald i are coefficients that control the shape of the lens. The cubic Alvarez lens is capable of providing a larger change in focal length compared to other varifocal lenses, making it useful in a variety of optical applications.

Configurations C through G may be all configured to achieve the same optical power (±5 D) and may be configured with Δn=0.06. The progression of these lens designs decreased the coefficient k values, which influences the term for the rate of refractive index power, and increased the coefficient R values, which influences the term for tilt. The effects of varying the two coefficient values on the WFE, required lateral shift, width/eyebox ratio, and the element thickness are shown in Table 1. Configuration C could not achieve sufficient eyebox size. As can be seen in Table 1, the WFE is lowest for Configuration G, which has the lowest coefficient k value and the largest width/eyebox ratio. This is not surprising, as introduced above, as minimizing the rate of optical power generation as a function or shift is expected to reduce aberrations. The trends show the importance of using the tilt term to minimize Δn and to optimize performance.

Configurations E and F may be optimized with the same R and k coefficients and may differ only in the lens element thickness. By increasing the thickness, a smaller lateral shift was required, but the WFE increased. This is also expected, as increasing thickness from the infinitely thin ideal increases aberrations.

Configurations H and I differ primarily on the required Δn value; Configuration H was implemented with Δn=0.06 and Configuration I was implemented with Δn=0.12. As expected, a larger Δn value achieves a larger OPD, which allows for Configuration I to achieve an optical power that is twice that of Configuration H, in a configuration 22% thinner and with a smaller 6.

Both Δn values are compatible with the print equipment. Nevertheless, Configuration H was chosen for implementation in the vision correction insert, as the available Δn=0.06 ink set met the specification, and it allows for more control over dispersion.

U.S. Pat. No. 9,855,752 B2 is incorporated by reference herein for all purposes. As noted therein, to create the bitmaps that are communicated to each printheads during fabrication, the configurations are first reduced to refractive index value volumes, n(x, y, z). Using the three-dimensional halftoning algorithms that accommodated the ink-diffusion characteristics, the gradient index profiles may be translated to bitmap-print patterns, which determined the spatial density patterns for the droplets from optical primary ink. As a simple binary-ink pair was used to fabricate the lens elements in this effort, two bitmaps may be required: one for the ‘high index’ and one for the ‘low index’ optical ink. As for simplicity, the cubic polynomials were not varied as a function of the axial coordinate, so that the same two bitmaps may be used to fabricate each layer of the device.

### VII

GRIN lens configurations can be optimized for operation in the visible, infrared, terahertz, and RF portions of the electromagnetic spectrum. The interaction of light with solids takes place through different mechanisms, depending on the type of material and the range of wavelength investigated. Insulators or dielectrics are typically transparent to visible light while most semiconductors are opaque to visible light yet transparent to infrared radiations; in contrast metallic solids appear shiny because they reflect all wavelength up to the ultraviolet region. The optical properties of a solid depends on its chemical composition and its structural properties and vary for every material.

When electromagnetic radiation impinges upon a material it interacts by polarizing the molecular units, producing oscillating dipole moments. This interaction results in several observable optical phenomena such as reflection, transmission, absorption, or scattering. The classical model of light propagation assumes that the oscillating electric field can interact with several different types of dipole oscillators within the material. Different dipoles are usually accessed by light wave from different frequency range depending on their mass.

The propagation of light through materials is described by a wave equation similar to the one that describes light travel in a vacuum (free space). The refractive index, n, describes how matter affects light speed: through the electric permittivity E and the magnetic permeability μ.

The refractive index (RI) is the measure of how light propagates through a material. The refractive index is a wavelength-dependent quantity and is a complex quantity. The complex RI is usually expressed as

n=η+i k=(μ∈/μ₀∈₀)^{1/2}=(μᵣ∈ᵣ)^{1/2}, (19)

where η is the real portion of the RI also defined as the ratio of the wave velocity in vacuum to the velocity in the medium, η=c v, and k is the extinction coefficient, which is directly related to the absorption coefficient; ε₀=permittivity of free space, ε=permittivity, εᵣ=relative permittivity, μ₀=permeability of free space, μᵣ=relative permeability. Relative permittivity can be expressed as εᵣ=ε/ε₀.

The real part of the RI describes the change in velocity or wavelength of a wave propagating from a vacuum into a medium, defining the extent the light rays can bend, or refract, when passing from one medium to another, while the imaginary part is a measure of the dissipation rate of the wave in the medium. For the optical domain, where μᵣ=1,

n=(∈/∈₀)^{1/2}=(∈ᵣ)^{1/2}. (20)

The relative permittivity is sometimes referred to as dielectric constant. The dielectric constant is the characteristic of an insulating material or a dielectric which represents its ability to store electrical energy in an electrical field. It shows how easily a material tends to be polarized when placed in an external electric field.

The dielectric constant k of a material is the ratio of its permittivity E to the permittivity of vacuum εₒ, so k=ε/εₒ. The dielectric constant is therefore also known as the relative permittivity of the material. A low-k dielectric is a dielectric that has a low permittivity, or low ability to polarize and hold charge. Low-k dielectrics are very good insulators for isolating signal-carrying conductors from each other. A high-k dielectric, on the other hand, has a high permittivity. Because high-k dielectrics are good at holding charge, they are the preferred dielectric for capacitors.

The relationship between the complex relative permittivity, also known as the complex dielectric constant, and the complex refractive index is given by

∈ᵣ+i∈_{img}=(n+ik)². (21)

The relationships between the real and imaginary parts are

∈ᵣ=n²−k² (22)

and

∈_{img}=2n k. (23)

The dielectric constant of a material and its refractive index are closely linked by the equation

κ=∈/∈₀=n², (24)

which can be applied to the static dielectric constants of non-polar materials, or to the high-frequency dielectric constants of any dielectric. As the refractive index n is complex quantity, ∈ᵣ must also be complex since n=(∈ᵣ)^{0.5}. The dielectric constant can vary significantly with frequency, n=n(ω) and k=k(ω), so that ∈ and ∈₀ are frequency dependent, εᵣ(ω)=relative permittivity or complex frequency dependent dielectric constant.

By manipulating the permittivity and permeability of the nanocomposite materials, the refractive index of wavefronts in the radio-frequency (RF) and millimeter (MM) wave spectral ranges can be manipulated. The index of refraction is complex, and the GRIN functions can include variation in either the real or imaginary part of the index of refraction function. The imaginary part of the refractive index is the extinction coefficient in the material—a measure of how much light is being absorbed at a given wavelength. In the optical domain, this governs how much the material absorbs light, and in the RF and MM wavelength domains, it determines the losses of the materials.

### VIII

In one example, the ‘Alvarez Lohmann-like’ (‘AL-like’) tunable GRIN optical devices are generalized by deriving a GRIN profile, hence conjugating optical element profiles, from the phase of the wavefront the combined optical elements are intended to produce as they are translated relative to one another laterally or rotationally.

The approach to combining the prescriptions of two or more GRIN optical elements with high-order polynomial functions to create combined variable lower order optical functions can be extended to a wide range of optical elements that implement a wide variety of optical functions. For example, conjugate fourth order optical elements can be combined to create cubic functions, and pairs of second order optical elements can be combined to create linear functions. It is also possible to conjugate multiple order polynomial profiles optical that combined create a lower-order polynomial optical functions. These devices can be used to provide variable optical power, to steer laser beams in multiple directions, to implement phased array optical devices, or to otherwise implement variable optical functions on waveforms.

In general, functions with odd-order terms tend to be asymmetric and cause beam steering, while functions with even-order terms tend to be symmetric and cause a change of focus. However, this is not a hard and fast rule and there are exceptions.

Inkjet print additive manufacturing allows for the GRIN polynomial functions implemented on the optical elements to be optimized in three dimensions. This provides more degrees of freedom than is provided by surface profiling only. This allows, for example, for implementation of plano-plano optical elements that comprise of three-dimensional GRIN functions that reduce aberrations, align optical axis, improve field of view, correct gaze angles, and eliminate distortions in ways that surface-figured optical devices cannot provide.

The OPD imparted by propagation of a wave through the local thickness of the homogeneous index device with a variable surface profile is OPD=(n−1) z(x, y), such that when applying a directional shift, δ, in the z direction, results in a wavefront deformation

W(x,y,δ)=(n−1)[z(x+δ,y)−z(x−δ,y)]. (25)

A comparable plano-plano GRIN device, composed of elements of equal thickness, t, can be designed the same optical path difference, OPD=(t)[n(x, y)−n₀]=(t) nᵣ(x, y), where the relative refractive index, nᵣ=n−n₀, and n₀ is the base refractive index value at which point OPD=0. When applying a directional shift, δ, in the z direction, results in a wavefront deformation is

W(x,y,δ)=t[nᵣ(x+δ,y)−nᵣ(x−δ,y)]. (26)

Notice that for no shift, δ=0, the contribution of the two elements cancel each other out, and no wavefront aberration is introduced.

In this way, for a fixed thickness device, the relative index, nᵣ(x, y) may be substituted for variable z(x, y), such that plano-plano variable GRIN patterned devices may be substituted to achieve the same spatially resolved OPD as is obtained with a variable surface figure thickness devices. However, it should be noted, that a plano-plano GRIN element can further control OPD by changing the index profile in three-dimensions n(x, y, z) which has more degrees of freedom than a surface-figured homogeneous-index optical element, where in the OPD is varied with only two dimensions. Even more degrees of freeform can be realized when freeform surface profiles are implemented on GRIN materials comprised of three-dimensional index gradients.

For simplicity and without limitations, it is assumed here that the polynomial function is freeform in the x and y planes and is constant in the z direction. Generalizing the Alvarez Lohmann type lens, it is possible for two elements with other like cubic functions to combine to create a variable power spheric lens. The approach herein can be extended to a broader range of conjugated GRIN optical functions, which that when linearly, angularly, or rotationally translated may be used to achieve variable optical power, beam steering, or other wavefront manipulations.

The change in optical phase of a plane wavefront passing through a surface figured homogenous index device is,

Δç(x,y,δ)=h(x,y,δ)*(n₀−1)2π/λ, (27)

where h is the total thickness of the device, which is assumed to be small to meet thin-lens approximations, and no is the base index.

The device acts as a neutral optical when the lateral shift between elements is zero—i.e., δ₀=0, such that for a given wavelength the device will add a constant phase to the incident wavefront

Δç(x,y,0)=z₂(x,y)−z₁(x,y)=ç₀. (28)

The functional surface profiles, z₁ and z₂, satisfy

h₀=h(x,y,0)=z₂(x,y)−z₁(x,y)=λ/(2π(n₀−1))ç₀. (29)

The two halves of the device must therefore have the same profile shape, offset by the equivalent neutral optical path length OPL, which may be written as

z(x,y)=z₂(x,y)−z₀−h₀/2=z₁(x,y)−z₀+h₀/2, (30)

in which h₀>max[z(x,y)]−min[z(x, y)].

For small shifts δ, the derivative of the profile x may be approximated as follows:

δz/δx=[[z(x+δ/2,y)−z(x−δ/2,y)]/δ]=[λ/(2πδ(n₀−1)]Δç(x,y,δ). (31)

Equating the change in phase introduced by the device to the target phase, ϕ′, required to produce at a specified working shift, δ=δ_{W}, between the two halves of the device, one may write ϕ′(x,y)=Δϕ(x, y, δ_{W}). The function z(x, y), which defines the profile of a generalized conjugating optical element for an arbitrary target phase ϕ_{T} at a working shift may then be represented as

z(x,y)=[λ/(2πδ(n₀−1)]∫ϕ_{T}(x,y)dx, (32)

where ϕ_{T}(x, y) is the aberration function. Eq 32 applies to small shifts in the x direction, but a series expansion may be applied for large phase angles. A double integral would be required for translation in both the x and y coordinates.

The equivalent of eq 32 for a plano-plano GRIN device is

n(x,y)=ϕ_{T}(x,y)*λ/[(2πδ)t](n₁−n₀)+n₀. (33)

The equation relates the refractive index profile of the optical element to its transverse aberration function, which describes the deviation of the wavefront from a perfect planar wavefront. The integral over the transverse aberration function represents the total phase shift experienced by the light as it passes through the optical element. By adjusting the transverse aberration function, the refractive index profile of the optical element can be tailored to achieve specific optical functions, such as focusing, imaging, and beam shaping.

The approach can be extended to other optical functions. The structure of a generic conjugated optical device is shown by example in FIG. 10 (a), wherein the two conjugate optical elements are defined by their surface profiles, z₁ and z₂, respectively, and are shifted against each other in the x direction along the internal surface z₀.

As discussed above, for a homogeneous refractive device, the optical path lengths across the device, OPL(x, y), are created by the summation of the thickness profiles of the two elements of the conjugate pair as they are translated relative to one another. It is understood that for any device with a homogeneous index n and a variable thickness z(x, y), a plano-plano GRIN device with an equivalent OPL(x, y) can be created with a device with a uniform thickness, t, implemented with a variable index profile defined by n(x, y). FIG. 10 (b) shows two plano-piano GRIN elements that implement the same OPL(x, y) pattern as the surface figured elements shown in FIG. 10 (a).

For a given output optical wavefront, a general two-part GRIN device can be made such that at one value of the shift, δ=δ₀, between the two GRIN parts, the device acts as a neutral optical element that does not change the wavefront of a propagating plane wave; however, the primary optical property of the device changes commensurate with S. The devices may be tuned by translation of the two parts (e.g., halves) in the x direction as was discussed above. However, shifts in y direction, both x and y directions, or rotational angle, a are also envisaged.

A simple device is a linear optical wedge. The wedge-shaped element can be used in various optical applications such as beam steering, wavefront correction, and optical metrology. By controlling the thickness and apex angle of the wedge, the refractive index profile can be tuned to achieve specific optical properties, such as deflection angle, wavefront curvature, and beam focusing.

A nonlimiting example of a linear wedge that can be introduced into a GRIN device has a distribution

n(x,y)=(n₀+n₁)/2+(x·(n₁−n₀))/(2·xₘₐₓ), (34)

where n₁ and n₀ represent the high and low refractive, index values respectively and xₘₐₓ is the maximum value of x. An example of a GRIN lens implementing a linear wedge function is shown in FIG. 12 at (a). More generally, FIG. 12 shows aspects of a conjugated GRIN devices comprised of plano-piano GRIN optical elements, wherein the rotational shift of the plano-piano GRIN optical elements cause the angle of deflection of the beam to change in azimuth or elevation as a function of the relative angle of rotation between the two. In the exemplary GRIN lens of FIG. 12 at (a), n₀=1.4, n₁=1.6, and xₘₐₓ=10 mm.

If a linear wedge function is rotated relative to its complement, they will counteract each other and, ideally, result in a net zero optical power if they are perfectly aligned and have identical properties. However, the wedge angle, in conjunction with the prism's index of refraction, causes light entering the prism to be deviated by a small angle. If the prism is rotated, the direction of deviation also rotates. As a pair of complementary wedge prisms are rotated relative to each other, the deviation introduced by the first wedge can be compensated by the second wedge to a varying degree depending on the relative angle between them. The aspect shown in FIG. 12 at (b) shows that at certain relative orientations, the two wedges can perfectly cancel each other's deviation, resulting in a collimated beam with no net deviation. Here 0 is the relative rotational translation between the two elements, where either or both may rotate. The phase can introduce change in both the azimuth and the elevational beam-pointing angle. The change in beam steering is not necessarily linear in the azimuth or elevational angle; it may sweep out arcs, circles, etc. The aspect shown in FIG. 12 at (b) shows that at other orientations, the two wedges can add up their deviations, resulting in a beam that is steered to a different direction. The aspect shown in FIG. 12 at (c) shows that it is possible to design the conjugate GRIN device such that as a function the direction of the rotation, the phase change is linear with respect to the angle of rotation, as a function of rotational direction.

Odd functions are symmetric about the origin, meaning f(−x)=−f(x). When one has a pair of odd-order surfaces (like cubic, quintic, etc.) and they are translated along the axis relative to each other, their effects tend to cancel out. This cancellation results in an optical system that behaves like a lower order system. Even functions are symmetric about they-axis, meaning f(−x)=f(x). When one has a pair of even-order surfaces (like quadratic, quartic, etc.) and they are translated along the axis relative to each other, their effects do not cancel out. Instead, they can add up or produce a different functionality depending on the specifics of the translation. Periodic patterns of wedges can be made into gratings, including diffraction gratings.

A cylindrical wedge introduces a phase

ϕ_{wedge}(x,y)=α×(n₀−1)*2π/λ (35)

for a wedge oriented in the x direction, where a is the angle of the wedge. Using a wedge function, gratings can be created that impart periodic tunable blaze angles. A cylindrical wedge, when linearly translated with its complement, will produce a net effect similar to a cylindrical lens. A cylindrical wedge refracts light in one direction only, while a cylindrical lens refracts light in one direction while leaving light in the orthogonal direction unchanged. When one has a pair of cylindrical wedges and slides them in the direction orthogonal to the refraction, the net effect is a lens-like behavior, similar to a cylindrical lens. The reason for this is that the refraction of light by a wedge is linearly dependent on the position across the wedge. By sliding two wedges against each other, one effectively creates a position-dependent phase delay that varies quadratically with position—this is the same kind of phase delay induced by a lens.

The phase change of eq 33 may be induced by a device with a parabolic GRIN profile for each of the conjugate optical elements of

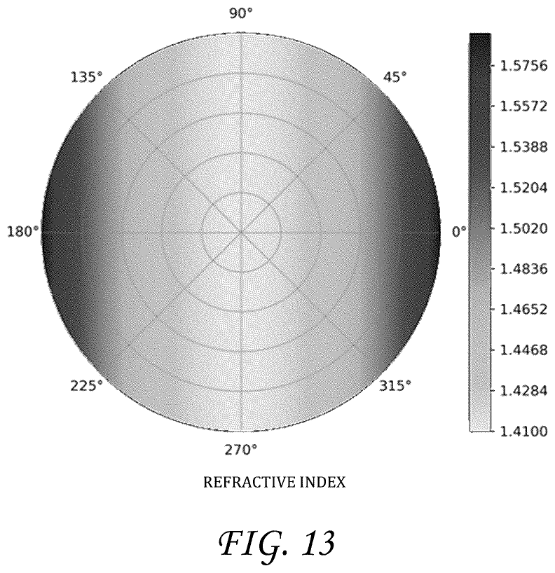

n_{r,wedge}(x,y)=n_{low}+(nₕᵢ−n_{low})/2+[(nₕᵢ−n_{low})/(δₘₐₓ](αx²), (36)

where mow is the base refractive index, nₕᵢ and n_{low} represent the high and low refractive, index values, δₘₐₓ is the maximum value of the translation, α is a coefficient that determines the strength of the wedge component. FIG. 13 shows aspects of a GRIN phase plate optical element with a refractive index distribution that implements a parabolic wedge index function across the device, such that when translated linearly relative to a complementary GRIN phase plate optical element it creates a variable cylindrical wedge function. More particularly, FIG. 13 shows an example of a GRIN lens with a parabolic wedge function created using α=1, n_{low}=1.41, (nₕᵢ−n_{low})=0.18, and δₘₐₓ=10 mm.

Whereas the cubic phase plates of an Alvarez lens, when combined in a conjugating GRIN device, creates a parabolic lens function, it is also possible to design a conjugate GRIN device that forms a spherical lens. The target phase of a spherical surface homogeneous index lens has a target wavefront of

ϕₛₚₕₑᵣₑ(x,y)=[R²−(x²−y²)]^{1/2}+R]*(n−1)*2π/λ. (37)

which represents the phase shift of light passing through a spherical surface with radius R and refractive index n. The first term, [R²−(x²−y²)]^{1/2}+R, represents the distance from the center of the spherical surface to the point (x, y) in the image plane taking into account the curvature of the surface. The second term, (n−1)*2π/λ, represents the phase shift of the light passing through the surface due to the difference in refractive index between the surface and the surrounding medium.

To create the phase plate optical elements, the phase delay function is divided between the two phase plates. Assuming that they are identical, each phase plate would need to impart half the target phase delay, so the phase function for each would be

ϕ_sphere,plate(x,y)=[R²−(x²+y²)]^{1/2}+R)*(n−1)*π/λ, (38)

where, n is the refractive index of the homogeneous index phase plate material, R is the radius of curvature of the spherical wavefront, and λ is the wavelength of the light.

In order to find the index distribution n(x, y) that achieves this, the relationship between refractive index and optical path length OPL (x, y) is considered. For a given ray, the OPL is the product of the refractive index and the physical path length.

A plano-plano GRIN lens doesn't have a curved surface, so R doesn't correspond to a physical feature of the lens. Instead, it's a parameter in the refractive index distribution that creates an equivalent optical effect to the original lens. The phase delay φ of a wavefront after passing through a homogeneous lens with index n and radius R is given by φ=2π/λ*(n−1)*R. To create the same phase delay with a GRIN lens, one may consider a spheric index profile. A common form for a GRIN lens index profile is n_{GRIN}(x, y)=n₀+α*(x²+y²) where no is the index at the center of the lens, a is the gradient constant, and x and y are the transverse coordinates. The sign of a determines if the lens converges light (is a positive lens) or diverges light (is a negative lens). The behavior is reversed for α<0 compared to α>0.

The refractive index distribution n(x, y, z) of the GRIN lens can be found by solving the eikonal equation, which connects the refractive index distribution to the phase of a wavefront. In the paraxial approximation, the eikonal equation can be written as ϕ_plate(x, y)=f n(x, y, z) ds, where the integral is along the optical path. For a plano-plano GRIN lens with a thickness t, with no index variation along the z axis, n(x, y) one may assume that the rays travel straight through the element, the differential length element can be assumed to be dz. This equation can be rearranged to solve for the refractive index distribution: n(x, y)=ϕ_plate(x, y)/t. This results in a conjugate optical element that may have a (x,y) coordinate distribution

$${n}_{sphere} ( x , y ) = {n}_{0} + ( {n}_{1} - {n}_{0} ) \cdot [ \text{} \frac{x \cdot ( \sqrt{{R}^{2} - ( {x}^{2} + {y}^{2} )} + 2 \cdot R )}{2 \cdot {δ}_{max}} + \frac{{tan}^{- 1} \frac{x}{\sqrt{{R}^{2} - ( {x}^{2} + {y}^{2} )}} \cdot ( {R}^{{2}_{- y} 2} )}{2} ] , \qquad ( 39 )$$

where nₒ is the low index and n₁ is the high index, and R is the radial term.

An example of a phase plate that can be translated rotationally is a spiral phase plate. A spiral phase plate (SPP) can be defined by a target wavefront of

ϕ_{SPP}(x,y)=a tan(y/x)*[[h*(n−1)]/λ]. (40)

The a tan(y/x) term generates an azimuthal phase ramp that increases linearly with the angle from the x-axis, giving the optical field a helical or spiral wavefront.

Applying eq 32 leads to a surface profile for each of the homogeneous index optical elements of

z_{SPP}(x,y)=[h/δ_{W}][x*a tan(y/x)−y/2 ln(x²+y²)]α, (41)

where h defines the phase per turn, and a is the angle. In this case, the term x*a tan(y/x)−y/2*ln(x\hat{ }2+y\hat{ }2) gives the phase of the optical vortex, which increases linearly with the azimuthal angle and logarithmically with the radial distance from the origin. The parameter a allows for adjustment of the topological charge of the optical vortex, and h/δ_{W} controls the overall phase ramp.

The GRIN equivalent is derived by eq 33 by creating the equivalent equation for the optical path difference.

n_{SPP}(x,y)=n₀+(n₁−n₀)*[h/δW]*[x*a tan(y/x)−y/2*ln(x\hat{ }2+y\hat{ }2)]*α/t. (42)

A helical phase distribution is a spiral phase plate, which introduces a phase delay that increases azimuthally around the center of the plate. When a helical phase distribution is counter-rotated with its complement, the resulting phase delay across the beam can either add up or cancel out, depending on the rotation angle and the specific values of the topological charges. If the two phase plates have equal and opposite topological charges and are perfectly aligned, the phase delay introduced by one plate will be exactly canceled out by the other, resulting in a collimated beam. If they are slightly misaligned, the combination can act like a lens, causing the beam to focus or defocus depending on the direction and degree of misalignment. If the two phase plates have different topological charges, or if they are rotated relative to each other by an angle other than 180 degrees, the phase delay will not cancel out perfectly. This results in a net phase gradient across the beam, which causes the beam to be steered or deflected in a particular direction. The direction and amount of deflection will depend on the specific values of the topological charges and the rotation angle.

For a helical profiles to form a varifocal lenses, when rotated relative to its complement, in the thin-lens approximation, a rotation angle-dependent refraction power D(φ) can be formulated in dependence on the azimuthal change of curvature of a first surface profile C₁(α) and a second GRIN profile C₂(α)

D(φ)=(n_{L}−n₀)/n₀[C₁(α)−C₂(α)], (43)

where n_{L} in is the refraction index of the lens body, no is the based refraction index of the GRIN element, α is the azimuth, φ is the rotation angle, and C=1/R, where R is the radius of the profile. Choosing a linear dependence of the surface curvature on the azimuth α, the curvature C₁(α) of the first lens body can be described as a function of α, C₁(α)=C₁₀+jα, where j is the linear factor of the curvature distribution, and C₁₀ is the curvature at α=0.

For an equivalent GRIN expression, one may substitute for the first surface,

D₁(φ)=nₒ+(n₁−n₀)*[C₁₀(α)+j₁α]/[C₁₀(α)+]j₁2π]. (44)

Rotating the second lens body, the respective opposing curvature also depends on the rotation angle φ. The equation of the curvature distribution C₂(α), where C₂=1/R₂, can be described in dependence on the rotation angle φ, where C₂(α)=C₂₀+j₂(α−φ) for φ ≤α≤2π, and C₂(α)=C₂₀+j₂(α−φ+2 π) for 0≤α≤φ, and C₂₀ is the curvature at α=0, where j₂ is the linear factor of the curvature distribution. Substituting for the second surface

D₂(φ)=nₒ+(n₁−n₀)*[C₂₀(α)+j₂(α−φ)]/[C₂₀(α)+j₂(α−φ)] for φ≤α≤2π (45)

and

D₂(φ)=nₒ+(n₁−n₀)*[C₂₀(α)+j₂(α−φ+2π)]/[C₂₀(α)+j₂(α−φ+2π)] for 0≤α≤φ. (46)

Equating, for convenience, the linear factors j₁=j₂=j,

D(φ)=nₒ+(n₁−n₀)(C₁₀−C₂₀+jφ)/(C₁₀−C₂₀+j2π) for φ≤α≤2π, (47)

D(φ)=nₒ+(n₁−n₀)(C₁₀−C₂₀+j(φ−2π))/(C₁₀−C₂₀+jφ) for 0≤α≤φ. (48)

The above equation describes the angle-dependent refraction power of a bifocal rotation optic. For every rotation φ≠0 there exist two lens sectors providing a certain refractive power.

The curvature varies such that lens sectors of two opposing lens bodies will result in the same refraction power over the whole azimuth range in the initial state. A rotation of one of the lens bodies by an angle φ around the optical axis will change the two opposing curvatures, resulting in a change of refraction power. Two sectors with different tunable optical refraction powers are formed by mutual rotation, thus resulting in a tunable bifocal optics.

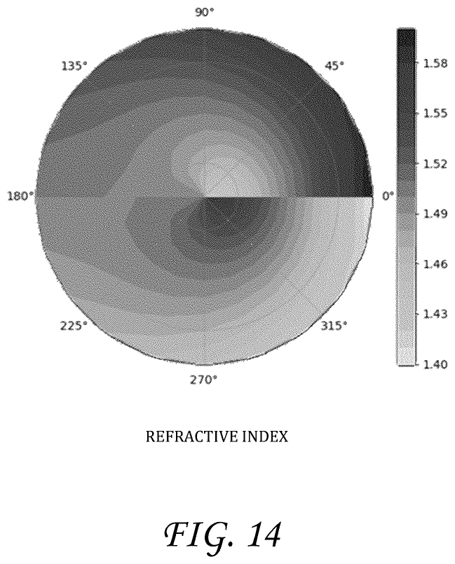

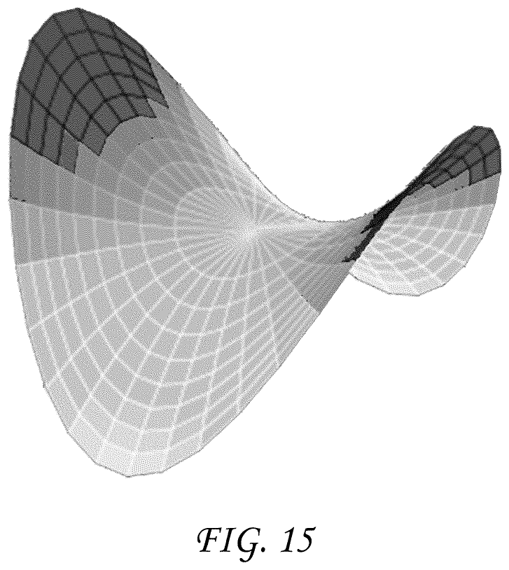

FIG. 14 shows aspects of an example of a GRIN phase plate with an index distribution that implements a helical phase function, wherein the index of refraction gradient changes radially as a function of the angle α. The index scale shows the range of refractive index values; showing a range from a low refractive index value of about 1.4 to a high refractive index value of about 1.6. Proceeding counterclockwise, at 0° the radial gradient distribution changes from a convex index function to a concave index function. Proceeding counterclockwise the second derivative of the radial index gradient becomes less positive, gradually flattens, and reaches a minimum at 180°. At 180°, the radial gradient distribution switches from concave to convex, and proceeding counterclockwise, the second derivative of the radial gradient distribution gradually increases until it reaches 00 where the second derivative is at its maximum negative value.

Toroidal optical elements may also be used in conjugated GRIN devices. Toroidal lenses are anamorphic optical elements, which primarily have a transmission function corresponding to that of two crossed cylindrical lenses, which may have different focal lengths. A toroidal lens may be thought of as a combination of two cylindrical lenses oriented at right angles to each other (crossed), and these cylindrical lenses may have different focal lengths. Both, cylindrical lenses and saddle lenses are a sub-group of toroidal lenses. A saddle lens has the transmission function of two crossed cylindrical lenses with opposite optical powers. The transmission function of a cylindrical lens may be obtained from that of a saddle lens by combining it with an adjacent spherical lens. A general toroidal lens may be assumed to be composed of a rotationally symmetric lens, and a saddle lens.

Assuming a thin lens approximation, the surface profile (height) a semi-planar toroidal lens is represented in cartesian (x, y) coordinates by

z(x,y)=[Fₓx²+F_{y}y²]/[2(n−1)], (49)

where n is the refractive index of the lens material. Fₓ and F_{y} are the cylindrical optical powers of the lens in the xz- and yz-planes, respectively, and may be positive (convex lens), or negative (concave lens). In a thin lens approximation, the corresponding transmission function for light with a wavelength

Tₜ=exp[−iπ/λ(Fₓx²+F_{y}y²)]. (50)

This transmission function of a semi-planar toroidal lens may be factorized

Tₜ=exp[−iπ/λ(Fₓx+F_{y}y)/2](x²+y²)*exp[−iπ(Fₓx−F_{y}y)/2](x²−y²)=T₁*T₂. (51)

There, the first factor T₁ corresponds to the transmission function of a parabolic (or a general spherical) lens with an optical power of (Fₓ+F_{y})/2 and the second factor T₂ to that of a quadrupole saddle lens with a ‘quadrupole’ optical power of (Fₓ−F_{y})/2, whose transmission function corresponds to that of two crossed cylindrical lenses with opposite optical powers of ±(Fₓ−F_{y})/2. Thus, the general toroidal transmission functions include the cases of pure spherical (parabolic) lenses if Fₓ=F_{y}, of pure saddle lenses if Fₓ=−F_{y}, and of cylindrical lenses if either Fₓ=0 or F_{y}=0.

Assuming a thin lens approximation, the GRIN profile of n(x, y) of a semi-planar toroidal GRIN lens is represented in cartesian (x, y) coordinates by:

n(x,y)=n₀−π/λt(Fₓx+F_{y}y)/2*(x²+y²)−π/λt(Fₓx−F_{y}y)/2*(x²−y²), (52)

where the device thickness is given by t. As above, Fₓ and F_{y} are the cylindrical optical powers of the lens in the xz-plane and yz-plane, respectively, and may be positive (convex lens), or negative (concave lens). Only quadratic terms are considered here, although correction terms of different order may be present in practical implementations, and it is assumed that the optical axes of the lens are aligned parallel to the x-axis and y-axis.

A single toroidal lens (e.g., a saddle lens or a cylindrical lens) typically cannot be used for imaging, since it affects the focal length in two orthogonal planes in a different way. However, this issue can be resolved by using two toroidal lenses (or two sets of combined, tunable toroidal lenses) placed at different positions within an optical system.

FIG. 15 shows aspects of a GRIN phase plate optical element implemented with a refractive index profile that implements a saddle function. A tunable saddle lens can be constructed by different methods. One of them is to just stack two individual saddle lenses with equal quadrupole optical powers into a single, combined conjugating GRIN device, a ‘conjugated-saddle lens’. A second method to realize a tunable saddle lens is to just combine two cylindrical lenses with opposite optical powers in a scissor arrangement, i.e., with a variable angle between the cylinder axes. More generally, any combination of two mutually rotatable cylindrical (or toroidal) lenses in combination with adequately chosen spherical lenses (which correct for additionally appearing spherical lens terms) can be used as a tunable combi-saddle lens.

Like an Alvarez lens, the insertion of two tandem-saddle lens lenses in an optical setups allows one to construct a zoom system, which acts as an afocal telescope, whose angular magnification can be continuously tuned by a rotation of the individual saddle lens elements around the optical axis. The working principle of a saddle lens telescope is based on the fact that a convolution of an input image with the transmission function of a saddle lens yields a Fourier transform of the input image, which is scaled by an amount that depends on the adjusted quadrupole optical power of the saddle lens.

When two saddle lenses are stacked—i.e., one mounted directly behind the other, and (in a thin-lens approximation), the corresponding ‘conjugated-saddle’ lens has a transmission function of a single saddle lens, but with a different quadrupole optical power that can be tuned by rotating one element with respect to the other around the optical axis.

Zooming can also be achieved by changing the mutual rotation angle of a set of four rotationally asymmetric lenses, namely of four cylindrical lenses, or of four saddle lenses. For example, the insertion of two conjugated-saddle devices in certain optical setups allows one to construct a zoom system, which may act as an afocal telescope, whose angular magnification can be continuously tuned by a rotation of the individual saddle lens elements around the optical axis. FIG. 16 shows, at (a), aspects of an example zoom lens comprising two conjugated GRIN devices that are positioned relative to one another along the optical axis and are positioned relative to one another along the optical axis, between surface figured homogeneous index lenses. Each conjugated GRIN device is comprised of a pair of GRIN optical elements that are positioned relative to one another along the optical axis, such that the optical Fourier transform of the first tunable conjugated GRIN device is projected onto the plane of the second tunable conjugated GRIN device. In the aspect shown the second tunable conjugated GRIN device is positioned after the focal point of the first tunable conjugated GRIN device. When the GRIN optical elements are translated linearly or rotationally relative to one each other, they change the focal length of the associated conjugated GRIN device, resulting in a change in magnification of the zoom lens; at (b) an aspect of an afocal arrangement of two conjugated GRIN devices, positioned between homogeneous index lenses, wherein the second conjugated GRIN device is positioned at the focal plane of the first conjugated GRIN device. In other words, panel (b) of FIG. 16 shows an example of two conjugated-saddle devices, configured between two homogeneous index lenses, to form a zoom telescope, which have stable image and object planes as a function of magnification.

These devices can be applied to any portion of the electromagnetic (EM) spectrum including the optical, radio-frequency (RF) or millimeter wavelength regions. Hereinafter, nanocomposites refer to materials which sized at <λ/10.

### IX

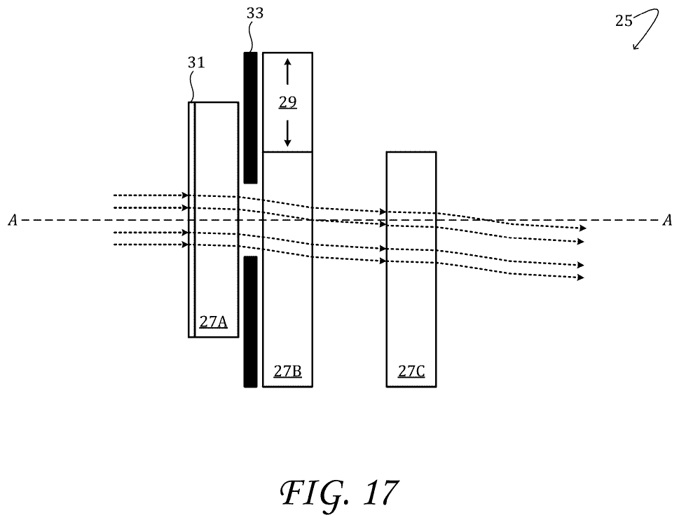

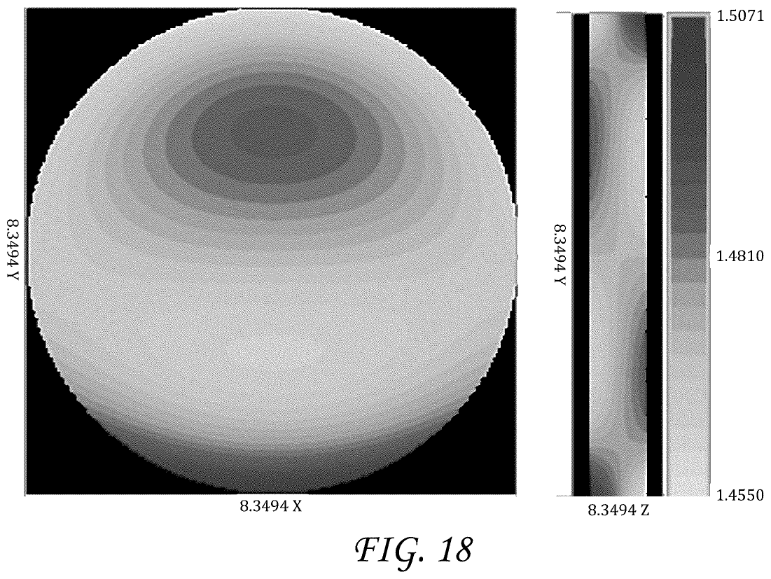

FIG. 17 shows aspects of an example optic 25 configured for variable wavefront shaping of electromagnetic (EM) radiation. The wavelength band of the EM radiation is not particularly limited in this disclosure; the EM radiation may comprise visible, near-infrared, infrared, millimeter-wave, or radio-frequency radiation, for instance. Optic 25 comprises a first optical element 27A including a solidified heterogeneous coalescence of nanocomposite material providing a first complex dielectric-function gradient. Optic 25 also comprises a second optical element 27B including a solidified heterogeneous coalescence of nanocomposite material providing a second complex-dielectric function gradient. Any, some, or all of the optical elements of optic 25 may comprise nanoparticles embedded in a cured polymer. Such nanoparticles may include oxide, semiconductor, fluoride, metal, hexaferrite, chalcogenide, ferrite, carbon, and/or hexaferrite, for example—e.g., materials with hollow cores or configured in core-shell architectures. Any, some, or all of the optical elements may be fabricated via inkjet-print fabrication, though other modes of fabrication are also envisaged. In some examples the nanocomposite materials are formulated for achromatic or apochromatic performance. In other examples, the wavelength-dispersive properties of the nanocomposite materials may impart a wavelength dependence to the variable wavefront shaping.

The first and/or second complex dielectric-function gradient may be a freeform gradient, a non-radially symmetric gradient, a non-axially symmetric gradient, or an anamorphic gradient, for instance. In some examples the first and/or second complex dielectric-function gradient comprises a permittivity or permeability gradient. Generally speaking, the first or second complex dielectric-function may vary radially (perpendicular to optical axis A), and/or axially (in the z direction, along A). In some examples the complex dielectric function characterizing the first and second optical elements may vary in three dimensions. In some examples the first and/or second complex dielectric-function gradient may be modified by laser radiation. The first and/or second complex dielectric-function gradient may comprise a real part usable to manipulate the EM radiation received into the first optical element. In some examples the first and/or second complex dielectric-function gradient may also comprise an imaginary part.

As shown in FIG. 17, first optical element 27A and second optical element 27B are arranged in tandem along optical axis A; together they provide wavefront shaping that varies according to the displacement of the first optical element relative to the second optical element. In some examples, displacement of first optical element 27A relative to second optical element 27B changes the focal length of optic 25. In some examples the displacement changes the direction of the beam exiting the second optical element relative to the direction of the beam entering the first optical element. In some examples the displacement imparts the effect of a variable wedge function on the incident EM radiation. In some examples the displacement reproduces the effect of a variable phase plate on the EM radiation. In some examples the displacement reproduces the effect of a variable blazed grating on the EM radiation.

In order to effect the displacement of first optical element 27A relative to second optical element 27B, optic 25 includes an actuator 29. In some examples the actuator includes a piezoelectric motor configured to translate the first or second optical element. In some examples the actuator includes an integrated micro-mechanical actuator configured to translate or rotate the first or second optical element. In some examples the actuator is configured to rotate the first or second optical element about optical axis A.

Optic 25 of FIG. 17 includes an anti-reflective coating 31 arranged on the first and/or second optical element. Optic 25 may be configured to transmit EM radiation only through an area of overlap between the first and second optical elements. In the example shown in FIG. 17, optic 25 includes at least one opaque baffle 33 arranged between first optical element 27A and second optical element 27B.

The range of applications of optic 25 is not particularly limited. The optic may be arranged in a vision-correcting device, an optical scanner, a variable-magnification telescope, a variable-magnification microscope, for instance, or in a head-up display configured for virtual- or augmented-reality applications. In some examples, the optic is configured to emit a light field or hologram—e.g., the optic may be a light-field or computational-imaging optic. In some examples optic 25 may be arranged in an antenna. To support these applications, among others, first optical element 27A and/or second optical element 27B may be integrated with one or more structural elements to facilitate mounting. In some examples the first and second optical elements may be configured for dynamic illumination.

In some examples, each optical element in optic 25 may be configured to model a conventional spherical lens. In other examples, the first and/or second complex dielectric-function gradient may Fresnel implementations of the desired complex or freeform dielectric-function gradient. In some examples the first and/or second complex dielectric-function gradient may comprise a segmented implementation of a desired complex or freeform dielectric-function gradient. In some examples the first and/or second complex dielectric-function gradient may be a gradient of a function of polynomial terms higher than third-order, to reduce aberrations or otherwise improve optical performance quality.

The number of optical elements in optic 25 is not particularly limited. In the example illustrated in FIG. 17, optic 25 includes a third optical element 27C including a solidified heterogeneous coalescence of nanocomposite material providing a third complex dielectric-function gradient arranged in the optical path of the first and second optical elements, and configured to correct for aberrations. More generally, the first and second optical elements, etc., may be arranged in an array of analogously configured optical elements. In such an array the complex dielectric-function gradient may vary in dependence on the position of each optical element in the array. Alternatively, or in addition, the size of each optical element may vary in dependence on the position of that optical element in the array. Alternatively, or in addition, the orientation of each optical element may vary in dependence on the position of that optical element in the array. In some examples the first and second optical elements may be tiled in a square, hexagonal, triangular, circumscribed circular, or chirped lattice configuration. In some examples the first and second optical elements may be tiled in a cubic, square, hexagonal, triangular, circular, or chirped packing.

FIG. 16 shows at (a), aspects of an example optical system 39 configured for variable focus. The system comprises a first optic 25A including first and second gradient complex dielectric-function optical elements 27F and 27G, arranged in tandem along an optical axis, which together provide an optical power that varies according to a displacement of the first optical element relative to the second optical element. The system further comprises a second optic 25B including third and fourth gradient complex dielectric-function optical elements 27H and 271, arranged in tandem along an optical axis, which together provide an optical power that varies according to a displacement of the third optical element relative to the fourth optical element. In this example the focal lengths of the first and second optics are adjustable relative to each other.

In some examples, system 39 may include at least one additional lens element (not shown in FIG. 16 (a)) arranged between the first optic 25A and second optic 25B. In some examples the dispersive properties of the first and second optics are matched to achieve achromatic performance. In system 37 a collimator lens system 41 is arranged between the source of the EM radiation and first optic 25A.

FIG. 16 (b) shows aspects of two example GRIN optics, which have an angular magnification that changes with rotation of each element relative to its conjugate optical element. When configured in a pair and configured with an additional optic, a zoom lens is formed. Setups allows one to construct a zoom system, which acts as an afocal telescope, whose angular magnification can be continuously tuned by a rotation of the individual saddle lens elements around the optical axis.

Additional support for the examples above is provided in FIGS. 17 through 20. FIG. 18 shows aspects of an example of a GRIN phase plate in which the complex dielectric-function gradients change in three coordinate dimensions. FIG. 12 (a) shows an example of a beam-steering conjugated GRIN device effected by a pair of GRIN phase plate optical elements, wherein the rotational displacement of the GRIN phase-plated elements relative to its complement causes beam steering. FIG. 12 (b) shows aspects of a rotational shift of an example pair of plano-plano GRIN phase plate optical elements—viz., the accumulated phase achieved by the combined index of refraction profiles of the pair as they are rotated relative to one another, cause the angle of deflection to change as a function of the angle of rotation. In the aspect shown, at one angle the accumulated phase is uniform across the conjugated GRIN device is uniform such that the beam is not deflected. The illustration shows rotational phase functions, which, as they shift relative to one another, cause the beam to deflect. When there is no shift of the elements relative to each other (φ′=0), the beam is undeflected from the incident orientation. The azimuthal angle φ′ of the beam may be swept (dashed line) by co-rotation of the prism pairs. In the aspect shown in FIG. 12 (c) the angle of deviation is linear with respect to the angular displacement between the complementary pair and the direction of the angle of the deflection is dependent on the direction of the relative rotation of the pair.

### X

This section provides additional development of GRIN formulas and details linear-translation and rotational-translation GRIN distributions that can be used, including quadrupole, torroids, etc., for both beam steering and varifocus applications.

The Alvarez lens is typically configured with a cubic function given by

n(x,y)=n₀+a₁x+a₂y+a₃(x³−3xy²), (53)

where n(x, y) is the refractive index of the lens at a given point (x, y), no is the average refractive index, and a₁, a₂, and a₃ are coefficients that determine the shape of the lens. The cubic function has a saddle shape, which allows for the lens to perform both positive and negative refraction.

When a GRIN Alvarez lens with the function n(x, y)=n₀+aᵢx+a₂y+a₃(x³−3 x y²) is translated linearly with its opposite, the combined optical function can be described by the equation

n_comb(x,y)=n₀+a₁x+a₂y+a₃(x³−3x y²)+(d²/2)(∂²n/∂x²+∂²n/∂y²), (54)

where ∂²n/∂x² and ∂²n/∂y² are the second partial derivatives of n(x, y) with respect to x and y, respectively.

The optical power of the combined lens can be calculated by taking the gradient of the refractive index n_comb(x,y),

P(x,y)=−(1/n)∇n_comb(x,y), (55)

where n is the refractive index of the surrounding medium and the gradient operator V is given by ∇=(∂/∂x)i+(∂/∂y)j. The optical power describes the direction and magnitude of the light's path as it passes through the lens and can be used to determine the focal length and other optical properties of the lens.

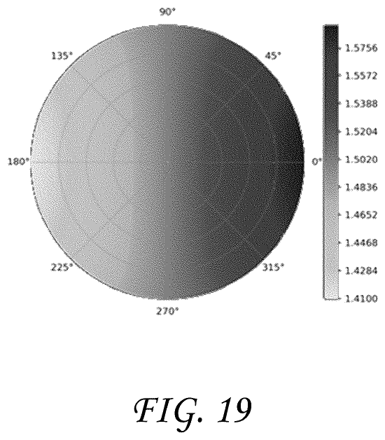

FIG. 19 shows aspects of a GRIN phase plate optical element implemented with a refractive index profile that implements a cubic index function, where the GRIN phase plate optical element is designed to change the focus of a beam when translated relative to a complementary GRIN phase plate optical element. Here the Alvarez lens equation is expressed as a fourth-order polynomial equation that describes the variation of the refractive index along the x and y axes of a lens. The general form of the equation is

n(x,y)=n₀+a₁x+a₂y+a₃(x²+y²)+a₄(x²−y²)+a₅(2xy)+a₆x(x²−3y²)+a₇y(3x²−y²)+a₈x²y+a₉xy². (56)

This equation has nine coefficients (a₁ to a₉) and includes terms up to fourth order. The x²−y² term gives it the shape characteristic of Alvarez lenses, and the additional terms provide further control over the lens's refractive properties. The higher-order terms, such as x³, y³, x²y, and xy², can introduce additional complexity and curvature to the GRIN profile, allowing for greater control over the lens's optical properties, which can be used to remove aberrations. Although not shown, the use of three-dimensional index variation, n(x, y,z) can be used to further reduce aberrations and better accommodate designs which deviate from the paraxial approximation.

Returning briefly to FIG. 15, this drawing shows aspects of a general saddle lens. An example of a saddle function is f(x, y)=x²−y². A plan-plano GRIN lens with a refractive index distribution shaped like a saddle function is a type of lens where the index gradient curvature is positive in one direction and negative in the orthogonal direction. This is also called a hyperbolic paraboloid shape. A GRIN saddle lens is given by an index distribution n(x, y)=n₀+a*(x²−y²), where no is the base refractive index, a is a constant that determines the strength of the saddle lens effect, and x and y are the coordinates in the plane of the lens.

If two lenses with opposite refractive index distributions shaped like a saddle function are rotated relative to each other, the resulting lens can be modeled mathematically by multiplying the transmission functions of the two lenses in the frequency domain.

The transmission function of a GRIN lens is given by the following equation,

T(x,y)=exp[iϕ(x,y)]=exp[i*2π*a*(x²−y²)*t/λ], (57)

where i is the imaginary unit, t is the thickness of the device, and a is a constant that determines the strength of the lens. The coefficient a is the same for both the x and y directions in the quadratic term, resulting in a saddle shape where the curvature in the x and y directions is equal and opposite. If the coefficients differ, an elliptical rather than a saddle shape is obtained.

Assuming that the refractive index distribution of the first lens is given by f(x, y) and that of the second lens is given by −f(x, y), the combined transmission function can be written as

T(x,y,θ)=exp[i*2π*((ax*(x cos θ+y sin θ)²−ay*(y cos θ−x sin θ)²)*t)/λ]. (58)

The actual shape and properties of the combined lens will depend on the specific parameters of the two lenses used and the angle at which they are rotated relative to each other.

Rotational translation will now be described. The mathematical description of a change in optical power with rotation as a change in focal length with rotation with respect to the inverse of the lens function can be expressed as:

f(θ)=1/D(θ), (59)

where D(θ) is the distribution function of the GRIN lens and f(θ) is the focal length at angle θ. If the optical power changes linearly with respect to rotation, then the focal length will also change linearly with respect to rotation, as expressed by:

f(θ)=aθ+b, (60)

where a and b are constants that depend on the specific GRIN lens design. The inverse function of this equation can be used to determine the distribution function D(0) that would produce a linear change in focal length with respect to rotation.

To make a cubic Alvarez-like lens varifocal with rotation, one may add higher-order terms to the refractive index distribution equation that depend on the rotation angle. One way to do this is to introduce a parameter that controls the variation of the refractive index distribution with the rotation angle. This can be done by adding a term proportional to the sine of the rotation angle to the refractive index distribution equation.

A possible equation for a varifocal cubic Alvarez lens with rotation is

n(x,y,θ)=n₀+a₁x+a₂y+a₃(x³−3xy²)+a₄ sin(θ)(x³−3xy²), (61)

where θ is the rotation angle, and a₄ is a parameter that controls the variation of the refractive index distribution with the rotation angle. The coefficients a₃ and a₄ introduce angular dependence in the refractive index distribution. To achieve a change of focus with rotation, one may set non-zero values for a₃ and/or a₄. These coefficients determine the strength and nature of the angular variation. The term a₃(x³−3 xy²) represents the cubic component of the refractive index distribution, which gives the lens an Alvarez-like shape. The sin(θ) term associated with a₄ allows for an angular modulation of the refractive index. The term a₄ sin(θ)(x³−3 xy²) introduces a sinusoidal variation in the refractive index distribution as a function of the rotation angle θ, further enhancing the varifocal properties of the lens. This equation has the same cubic dependence on x and y as the original cubic Alvarez equation, but it also includes a sinusoidal dependence on the rotation angle θ.

When the lens is rotated relative to its complement, the sinusoidal term in the refractive index distribution equation produces a shift in the focal length of the lens that depends on the rotation angle. As the lens rotates, the focal length changes in a varifocal manner, allowing the lens to focus at a different distances depending on the rotation angle.

Δf(0)=−(1/2)k(Δn)a₄ sin(2θ), (62)

where Δf(θ) is the change in focal length as a function of rotation angle θ, Δn is the difference in refractive index between the GRIN lens, a₄ is the coefficient of the sin(θ) term in the GRIN equation, and k is a constant that depends on the specific GRIN distribution. The change in focal length is determined by several factors, including the coefficient a₄, which controls the extent of the varifocal effect, the change in refractive index denoted by Δn, and the rotation angle θ. The term (1/2)k is a constant that depends on the specific design of the lens. The sin(2 θ) term indicates that the change in focal length is sinusoidal with respect to the rotation angle, with a maximum change occurring at θ=π/4 and 3π/4, and a minimum change at θ=0, π/2, and π.

When rotated relative to a negative version of itself, the following phase equation may be used:

f(θ)=−λ/2πn₀(Δn/λ)R(θ), (63)

where λ is the wavelength of light, Δn is the difference between the maximum and minimum refractive index. The term −λ/2π n₀(Δn/λ) is a constant that relates to the refractive index difference Δn and the wavelength λ. The function R(θ) represents the rotation function or the angular dependence of the phase delay. The specific form of the rotation function will depend on the optical system and the desired properties. It can be a simple trigonometric function or a more complex function depending on the specific situation. The term rotation-dependent term R(θ) may be given by:

R(θ)=[a₁²+a₂²+(a₃+2a₄)²]sin²(θ/2)+4a4² cos⁴(θ/2)+4a₃a₄ sin²(θ/2)cos²(θ/2). (64)

There are various n(x, y) distributions that can allow for a linear change in optical power as a function of rotation, some of which are:

n(x,y)=n₀+a₁x+a₂y+a₃ cos(2θ), (65)

where the coefficient a³ cos(2θ) is responsible for introducing angular-dependent variations in the refractive index. The value of a₃ determines the amplitude of the refractive index modulation caused by the cos(2θ) term. By adjusting a³, one may control the extent of the focal length variation; or

n(r,θ)=n₀+r(a₁ cos θ+a₂ sin θ)+a₃ sin(2θ)), (66)

where the coefficient a₃ introduces angular-dependent variations in the refractive index, specifically a sinusoidal modulation with a period of 2θ; or

n(x,y)=n₀+a₁x+a₂y+a₃ sin(θ)+a₄ cos(θ), (67)

where the coefficients a₃ and a₄ contribute to the angular-dependent variations in the refractive index. The a₃ sin(θ) term and the a₄ cos(θ) term introduce sinusoidal modulations in the refractive index as a function of the rotation angle θ. To achieve varifocality, non-zero values for both a₃ and a₄ are typically used. The specific values and the ratio between these coefficients would determine the magnitude and nature of the focal length variations.

Adjusting these coefficients would allow control over the extent of the focal length change as the lens is rotated; or,

n(r,θ)=n₀+Σ[A n rₖ+Bₙ(r)cos(nθ)+Cₙ(r)sin(nθ)], (68)

where Aₙ, Bₙ(r), and Cₙ(r) are coefficients that depend on the particular GRIN function; or

n(r,θ)=n₀+a₁r cos(θ)+a₂r sin(θ)+a₃ sin(θ)+a₄ cos(θ). (69)

Quadrupole optical power implies that the optical power of the lens changes quadratically with respect to the transverse position of the beam. However, linear change in focus with respect to rotation can be achieved using various higher order GRIN distributions that may not exhibit quadrupole optical power.

A quadrupole optical power GRIN lens has an asymmetric structure and induces a linear change in focus as it is rotated relative to its inverse. To achieve a Quadrupole GRIN lens with a linear change in optical power when rotated, a suitable value of k can be chosen, and the power-law exponent p can be adjusted accordingly to achieve the desired index profile. The rotational symmetry of the lens can then be exploited to achieve the desired linear change in optical power.

One may calculate the optical power of the lens at a given angle θ as the sum of the paraxial optical power and the non-paraxial contributions, which can be expressed as:

P(θ)=P₀+P₂(θ), (70)

where P₀ is the paraxial optical power, given by:

P₀=(n₀−1)/f₀, (71)

and f₀ is the focal length of the lens in the absence of any rotation. The non-paraxial contributions to the optical power can be expressed as

P₂(θ)=(n₀−1)∫∫(x²+y²)[n(r,θ)−n₀]dxdy, (72)

where the integral is taken over the entire lens aperture.

Substituting the expression for the refractive index distribution and simplify the expression by transforming to polar coordinates, the total optical power of the lens as a function of angle θ can be expressed as:

P(θ)=(n₀−1)/f₀+πR⁵(n₀−1)[a₁ cos(θ)+a₂ sin(θ)+a₃ cos(2θ)+a₄ sin(2θ)]/5. (73)

This expression shows that the optical power of the lens varies linearly with angle, with a slope determined by the quadrupole refractive index gradient coefficients a₃ and a₄.

The optical power of the lens is given by the second derivative of the refractive index with respect to the radial distance r from the optical axis, i.e.,

P(r)=−(1/n)(d²n/dr₂), (74)

where n is the refractive index.

Δf(θ)=−(1/n₀)d²n/dr²=−(1/n₀)[(6a₃x−6a₃y²+2a₄)cos²θ−12a₃xy sin θ cos θ+(−6a₃x²+6a₃y+2a₄)sin²θ], (75)

where x and y are the radial distances from the optical axis.

In polar coordinates:

n(r,θ)=n₀+a₁r cos(θ)+a₂r sin(θ)+a₃r³(cos(θ)³−3 cos(θ)sin(θ)²)+a₄r²(sin(θ)²−cos(θ)²). (76)

And the change in focus as a function of rotation θ is given by:

Δf=−λ/(2π)*(n_{L}−n₀)*D(θ), (77)

where: D(θ)=[n₀C₁(a)−n_{L}(C₁(a) cos(θ)+C₂(a) sin(θ))]/[n_{L}−n₀], and C₁(a)=1+a₁+3a₃ cos(θ)²+2a₄ sin(θ) cos(θ) C₂(a)=a₂+3a₃ sin(θ) cos(θ)−2a₄ cos(θ)².

The equation for a Quadrupole GRIN lens that has a linear change in optical power when rotated relative to itself can be expressed as

P(z)=P₀+kz, (78)

where P(z) is the optical power at a distance z along the optical axis, P₀ is the initial optical power at z=0, k is the rate of change of optical power per unit distance, and z is the distance along the optical axis.

One example of a GRIN distribution that can be used to achieve a Quadrupole GRIN lens with a linear change in optical power when rotated is a power-law distribution. In this case, the index profile is given by

n(r)=n₀[1+(k/d)(r/d)^{p}], (79)

where n(r) is the refractive index at a distance r from the center of the lens, no is the refractive index at the center of the lens, d is the diameter of the lens, k is the rate of change of optical power per unit distance. P(z) represents the optical power of the lens as a function of the distance along the optical axis, as given in the equation P(z)=P₀+kz), where P₀ is the optical power at the center of the lens and k is the rate of change of optical power per unit distance, and p is a power-law exponent that controls the shape of the index profile.

Quadrupole optical power specifically describes the variation in optical power that arises due to changes in the second-order terms of the refractive index distribution. An example of a GRIN saddle function with a quadrupole optical power that can function as a toroidal lens is

n(x,y)=n₀+a₁x+a₂y+a₃(x³−3xy²)+a₄(x²−y²), (80)

where n₀ is the refractive index at the center, a₁ and a₂ are the linear refractive index coefficients, a₃ and a₄ are the higher-order refractive index coefficients, and x and y are the coordinates in the transverse plane. When this lens is rotated relative to its complement, it causes a change in focus that varies linearly with the rotation angle θ.

By choosing the coefficients a₁ and a_{z} to be equal in magnitude and opposite in sign, so that the linear variation of the index along the x direction cancels out the linear variation along the y direction, results in a purely quadratic variation along the diagonal direction.

Δf(θ)=2πkL²[n₀²+(2/5)a₁²+(2/5)a₂²+(8/35)a₃²+(4/35)(a₁a₂+a₂a₁)cos(2θ)+(2/35)(a₁a₃−a₃a₁)cos(3θ)+(2/35)(a₂a₃−a₃a₂)sin(3θ)], (81)

where θ is the angle of rotation of the lens, L is the length of the lens, k is a constant related to the material properties of the lens, and the coefficients a₁, a₂, and a₃ describe the variation of the refractive index along the x, y, and z axes of the lens, respectively. The coefficient a₄, which describes the variation of the refractive index along the diagonal of the lens, is not included in this equation because it does not affect the change in focal length due to rotation.

A cylindrical Quadrupole GRIN lens that has a linear change in optical power along the optical axis when rotated relative to itself can be designed using a specific refractive index distribution. The refractive index distribution that achieves this behavior is called a parabolic refractive index distribution. The parabolic refractive index distribution is given by

n(r)=n₀+Ar², (82)

where n(r) is the refractive index at a radial distance r from the center of the lens, n₀ is the refractive index at the center of the lens, A is a constant that determines the strength of the refractive index gradient, and r is the radial distance from the center of the lens.

For a cylindrical lens, the optical axis is the axis perpendicular to the cylindrical surface, so the linear change in optical power must be along this axis. Therefore, the parabolic refractive index distribution must be along the axial direction. This can be achieved by varying the refractive index as a function of the distance along the axial direction.

The refractive index distribution for a cylindrical Quadrupole GRIN lens with a parabolic refractive index distribution along the axial direction can be expressed as:

n(x,y)=n₀+A(x²+y²), (83)

where n(x, y) is the refractive index at a point (x, y) in the lens, n₀ is the refractive index at the center of the lens, A is a constant that determines the strength of the refractive index gradient, x and y are the coordinates of the point in the plane perpendicular to the optical axis. This GRIN distribution has a linear change in optical power along the optical axis when rotated relative to itself. Therefore, it should result in a linear change in focal length with rotation. The change in focal length Δf with rotation angle θ can be calculated using the following equation:

Δf=(n₀/2A)sin(2θ), (84)

where n₀ is the refractive index at the lens center and A is a constant related to the strength of the Quadrupole term,

A GRIN toroidal lens is a type of GRIN lens that has a refractive index that radially from the center of the toroid to its outer edge, which allows the lens to focus light in a unique way. The mathematical function that describes the refractive index of a GRIN toroidal lens is typically a variation of the power-law GRIN equation, such as

n(r)=n₀+a(r−R)²+b(r−R)³+c(r−R)⁴, (85)

where n(r) is the refractive index at a radial distance r from the center of the toroid, n₀ is the refractive index at the center of the toroid (i.e., the hole), a, b, and c are constants that determine the refractive index profile, and R is the radius of the toroid.

When two GRIN lenses are rotated relative to each other, they can function as toroidal lenses and cause a change in optical power. The specific change in optical power will depend on the exact parameters of the GRIN function and the angle of rotation. When these lenses are placed in close proximity, the refractive index distribution of one lens is the mirror image of the other lens. This creates an index profile that varies linearly with distance from the center of the lens in both the x-y and y-z planes. This linear variation in refractive index is similar to the surface shape of a toroidal lens and can therefore produce similar optical effects. One example of an index distribution that could be used to achieve this is

n(r,z)=n₀+(n₂−n₀)*(r/R)²*(1+a₁*cos(2θ)+a₂*cos(4θ))*exp(−z²/(2*L²)). (86)

Here, n₀ is the refractive index at the center of the lens, n₂ is the refractive index at the outer edge of the lens (at a radius R), r is the radial distance from the center of the lens, z is the axial distance along the optical axis, θ is the azimuthal angle, a₁ and a₂ are coefficients that control the degree of toroidicity in the lens, and L is a characteristic length scale that controls the axial variation of the index distribution. By rotating this lens relative to its inverse, the toroidal shape of the lens will cause a linear change in optical power along the optical axis.

The primary difference between a quadrupole lens and a toroidal lens when they are rotated relative to their inverse is in the direction of their power axis. In a quadrupole lens, the power axis is perpendicular to the optical axis, while in a toroidal lens, the power axis is parallel to the optical axis. As a result, when rotated relative to their complement, a quadrupole lens has a linear change in optical power, while a toroidal lens has a sinusoidal change in optical power. Additionally, the shape of the lens surface in a toroidal lens is different from that in a quadrupole lens, which affects other properties of the lens such as aberrations.

In general, the idea is to have two GRIN lenses with different saddle functions such that when they are rotated relative to each other, the resulting optical power distribution approximates that of a toroid. One possible mathematical approach is to consider the two saddle functions as perturbations of a toroidal function. The toroidal function can be expressed as

n(φ)=n₀+Δn cos(φ), (87)

where φ is the azimuthal angle, n₀ is the refractive index in the center of the toroid, and Δn is the index change due to the toroidal shape. The saddle functions can then be expressed as perturbations of this function, for example,

n₁(φ)=n₀+Δn cos(φ)+a cos(2φ)n₂(φ)=n₀+Δn cos(φ)+b sin(2φ), (88)

where a and b are coefficients that determine the strength and orientation of the saddle functions.

When these two saddle functions are combined, the resulting refractive index distribution is:

n(φ)=n₀+Δn cos(φ)+a cos(2φ)+b sin(2(φ+θ)), (89)

where θ is the relative rotation angle between the two lenses. This distribution can be approximated as a toroid when a and b are chosen appropriately and θ is small enough.

One example of a GRIN expression for a toroidal lens that can change the optical power when rotated relative to its opposite is

n(r,θ)=n₀+a₁r cos(θ)+a₂r sin(θ)+a₃r² cos(2θ)+a₄r² sin(2θ), (90)

where n₀ is the refractive index at the center of the toroid, r is the radial distance from the center of the toroid to a point in the lens, θ is the azimuthal angle measured from a reference direction, a₁ and a₂ are coefficients that control the linear variation in refractive index in the x and y directions, respectively, and a₃ and a₄ are coefficients that control the quadrupole variation in refractive index in the x and y directions, respectively.

The linear variation in refractive index in the x and y directions (a₁ and a₂ terms) causes a linear change in the focal length of the lens as it is rotated relative to its inverse. The quadrupole variation in refractive index in the x and y directions (a₃ and a₄ terms) can help to reduce aberrations and improve the quality of the beam steering.

When a cylindrical Quadrupole GRIN lens

n(x,y)=n₀+A(x²+y²) (91)

is rotated relative to its inverse, it creates a varifocal lens where the focal length changes parabolically with rotation.

To make a zoom lens using rotationally variant GRIN lenses, one could use a combination of toroidal GRIN lenses and quadrupole GRIN lenses. The toroidal GRIN lenses could be used to adjust the focal length of the system, while the quadrupole GRIN lenses could be used to adjust the optical power and correct for aberrations. To achieve zooming, the relative orientations of the lenses could be adjusted, either mechanically or electronically, to change the effective focal length of the system. By adjusting the relative orientations of the toroidal and quadrupole GRIN lenses, the user could control both the focal length and optical power of the lens system, allowing for a zooming effect. One approach is to use a series of GRIN lenses with different optical powers that can be selectively combined to provide the desired zoom range. For example, one may use a toroidal GRIN lens with a linear change in focus as a function of rotation to provide a small amount of zoom (e.g., 1.2× to 1.5×), and then use a series of quadrupole GRIN lenses with progressively larger optical powers to provide additional zoom (e.g., 2× to 5×).

Beam-steering will now be described. A beam-steering lens uses a GRIN distribution that causes a linear change in optical power with rotation. One such distribution is

n(x,y)=n₀+k(x²−y²), where k is a constant. (92)

The main difference between the two GRIN distributions is that the Quadrupole GRIN distribution

n(x,y)=n₀+A(x²+y²) (93)

creates a varifocal lens with a parabolic change in focal length, while the GRIN distribution

n(x,y)=n₀+k(x²−y²) (94)

creates a beam steering lens with a linear change in optical power. The change in focal length Δf as a function of the rotation angle θ can be expressed as:

Δf(θ)=2n f(0)sin²(θ/2) for the varifocal lens, (95)

where n is the refractive index at the center of the lens, f(θ) is the focal length at θ=0, and θ is the rotation angle, and

Δf(θ)=n f(0)sin(2θ) for the beam steering lens, (96)

where n is the refractive index of the lens and AO) is the focal length when it is not rotated, i.e., when θ=0. It represents the focal length of the lens when it is not rotated and serves as a reference point for calculating the change in focal length with rotation angle.

The difference between the two GRIN distributions is in the power of the sine function. The varifocal lens has a sine squared function which results in a parabolic change in focal length, while the beam steering lens has a sine function which results in a linear change in focal length.

For a varifocal lens with a GRIN distribution that varies linearly with radius, the phase change is proportional to the angle of rotation. For a beam steering lens with a GRIN distribution that varies sinusoidally with radius, the phase change is proportional to the square of the angle of rotation. In both cases, the phase change is related to the change in the OPL created by the lens as it rotates. This change in optical path length causes a change in the focal length or direction of the beam, depending on the application.

The OPL created by a GRIN lens is given by the integral of the refractive index along the path of light passing through the lens. If the optical path length created by the first GRIN lens is denoted OPL₁ and the optical path length created by the second GRIN lens as OPL₂, then the total optical path length difference between the two lenses as they rotate relative to one another can be expressed as:

OPL=OPL₂−OPL₁. (97)

This optical path length difference will cause a phase difference between the two lenses, which can result in various optical effects such as beam steering, focusing, or varifocal capabilities.

To make a lens that beam steers with rotation, an asymmetry is introduced in the lens design. One way to do this is to add a term that varies with the angle of rotation. This can be achieved by replacing x and y in the lens equation with expressions involving sin(θ) and cos(θ), respectively. For example, one may modify the GRIN lens equation used for linear shift

n(x,y)=n₀+a₁x+a₂y+a₃(x³−3xy²) (98)

to make it beam steer with rotation by replacing x with r sin(θ) and y with r cos(θ), where r is the radial distance from the center of the lens and θ is the angle of rotation.

n(r,θ)=n₀+a₁r sin(θ)+a₂r cos(θ)+a₃(r³ sin³(θ)−3r² sin(θ)cos²(θ)). (99)

Now, when the lens is rotated, the sin(θ) and cos(θ) terms will cause the refractive index to vary with the angle of rotation, resulting in beam steering.

There are several high-order GRIN functions that can perform beam steering when rotated relative to one another. Some examples include cubic and quartic GRIN distributions, which produce lenses that have different refractive indices along the x- and y-axes, allowing for astigmatism correction and beam steering. By rotating two lenses with the same cubic or quartic GRIN distribution, but with opposite signs, relative to each other, the combined lens can produce beam steering.

Spiral phase plates (SPP) introduce a spiral phase shift to the wavefront of a beam, which can produce a vortex beam or other types of structured light. By rotating two spiral phase plates with opposite handedness relative to each other, the combined system can produce beam steering. Axicon lenses are conical lenses that produce a Bessel beam or other types of non-diffracting beams. By rotating two axicon lenses with the same refractive index profile but opposite orientations relative to each other, the combined system can produce beam steering.

There are also other high-order GRIN functions that can also be used for beam steering, but the specific function that is optimal for a given application depends on several factors, including the desired level of steering, the size and shape of the beam, the wavelength of the light, and other optical parameters.

The combined function of two lenses with the same GRIN distribution, complementary to one another, as it relates to beam steering, can be described as follows. Let the GRIN distribution for the lenses be given by:

n(r,θ)=n₀+a₁r cos(θ)+a₂r sin(θ)+a₃r²+a₄r³ cos(θ)+a₄r³((1/3)sin(3θ)−(1/2)sin(θ))+ . . . (100),

where n₀ is the refractive index at the center of the lens, a₁, a₂, a₃, a₄, . . . are the coefficients of the GRIN distribution.

If the two lenses are rotated relative to one another by an angle θ, and the beam is incident along the z-axis, then the resulting phase shift of the beam at the output plane can be expressed as:

ω(x,y)=k[n(x,y)−n₀]t (101)

where k is the wavevector of the light, and t is the thickness of the lenses.

Assuming that the beam is a plane wave incident along the z-axis, the output field at the plane z=t can be obtained by taking the Fourier transform of the phase shift:

E(x,y,L)=F{exp[iφ(x,y)]}, (102)

where F{ } denotes the Fourier transform.

The resulting beam will be steered in the direction perpendicular to the axis of rotation of the lenses, with the amount of steering depending on the angle of rotation and the coefficients of the GRIN distribution. The exact form of the function will depend on the specific GRIN distribution used.

FIG. 12 shows aspects of a GRIN phase plates that operate similarly to Risley edge prims elements. The refractive index profile of a Risley prism can be approximated by a GRIN equation with only linear terms, such as: n(x)=n₀+a₁x. A GRIN phase plate with this distribution is shown in FIG. 12 (a). When this device is rotated with its complement, it will induce beam steering. The steering effect will be linearly proportional to the rotation angle and the coefficient a₁. The amount of beam steering will depend on the gradient of the refractive index distribution and the rotation angle.

The refractive index distribution of a GRIN lens that can act as an equivalent device to a Risley prism will have a sinusoidal variation, with a period that is equal to the pitch of the prism. Mathematically, the refractive index distribution can be expressed as

n(x,y)=n₀+Δn sin(2πx/p), (103)

where n₀ is the average refractive index of the lens, Δn is the amplitude of the refractive index variation, x and y are the Cartesian coordinates in the transverse plane, and p is the pitch of the prism. In this device, the refractive index varies sinusoidally along the x-axis with a period of p. When this device is rotated with its complement, it will induce beam steering by changing the propagation direction of the incident light based on the sinusoidal refractive index variation. The amount of beam steering will depend on the rotation angle and the amplitude of the refractive index variation (Δn).

Assuming that the two lenses are identical and rotate at different rates, then the angular deviation of the collimated light will change over time as the two lenses rotate relative to each other. The direction and magnitude of the angular deviation will depend on the relative orientation of the two lenses at any given time, which in turn depends on their respective rotation angles and rates.

It is possible that the two lenses could be designed such that their combined effect on the light results in a desired change in focal length or other optical property. However, designing such a system would require careful consideration of the individual lens properties, as well as the relative rates and orientations of their rotation.

One possible GRIN equation that can function like a beam scanner without abrupt changes is:

n(x,y)=n₀+Δn cos(2π(x/p+φ(y))), (104)

where n₀ is the refractive index at the center of the GRIN element, Δn is the maximum refractive index variation from n₀, p is the period of the refractive index variation, and φ(y) is a smooth function that varies the phase of the refractive index variation along the y-axis. By varying the function φ(y), the scanning pattern can be controlled without abrupt changes in phase. This type of GRIN element is known as a smoothly varying phase plate.

When two lenses with the same quartic GRIN distribution, but with opposite signs, are rotated relative to each other by an angle θ, the resulting combined lens will have a refractive index distribution that can cause beam steering. An example of a quartic GRIN distribution that can be used for beam steering similarly is:

n(x,y)=n₀+a₁x+a₂y+a₃x²+a₄y²+a₅x³+a₆y³+a₇x⁴+a₈y⁴, (105)

where n₀ is the refractive index at the center, a₁ and a₂ are linear coefficients, a₃ and a₄ are quadratic coefficients, a₅ and a₆ are cubic coefficients, and a₇ and a₈ are quartic coefficients. By adjusting the coefficients in the quartic distribution, the amount and direction of beam steering can be precisely controlled.
The quartic GRIN distribution, when scanned relative to its complement, can effectively change the effective focal length of the GRIN element. This allows for the ability to dynamically focus or defocus the beam as it is scanned. By adjusting the scanning parameters and the coefficients of the quartic distribution, the focal length can be modified to achieve different beam steering effects.

One possible equation to describe the combined refractive index distribution is:

n(x,y,θ)=n₀+a₁x+a₂y+a₃(x²+y²)+a₄(x³+y³)−a₄[(x cos θ+y sin θ)³+(−x sin θ+y cos θ)³], (106)

where n₀ is the background refractive index, a₁ to a₄ are coefficients that determine the strength of the GRIN distribution, and θ is the rotation angle between the two lenses.

The presence of the cubic terms in the refractive index distribution introduces a nonlinear phase modulation across the GRIN element. This nonlinearity allows for precise control over the phase profile of the transmitted light, resulting in controlled deflection or steering of the beam. By adjusting the coefficients in the distribution, the beam can be steered in a desired direction with high precision. The additional term involving the angle θ introduces a dependence on the rotation angle, allowing for variable steering angles. By rotating the GRIN element and its complementary counterpart, the combined effect of the refractive index distribution and the rotation enables the beam to be steered in different directions as the rotation angle changes. This provides flexibility in controlling the steering angle of the beam. The combination of the quadratic and cubic terms in the refractive index distribution allows for more complex beam manipulation. The quadratic term contributes to focusing and defocusing effects, while the cubic term introduces asymmetry and non-uniform steering. This enables more versatile beam shaping and steering capabilities, allowing for customized beam trajectories and profiles.

An example of a higher-order equation that could function like beam steering device is:

n(x,y)=n₀+Δn[sin(2πx/p)+b₁ sin(4πx/p)+b₂ sin(6πx/p)+ . . . ], (107)

where b₁, b₂, etc. are coefficients that determine the strength of the higher-order terms. The additional terms can help smooth out the phase transition between the two lenses, resulting in a more gradual change in phase as the beam is scanned.

Another phase distribution that can be used for beam steering

φ(r,θ)=mθ+l(r)exp(imθ), (108)

where m is the topological charge (the number of spiral arms or lobes in the resulting phase pattern.), l(R) is the radial distribution function, and R and θ are the polar coordinates in the transverse plane. The radially symmetric refractive index distribution where the refractive index depends only on the radial distance from the center, R. The equation, with its radial symmetry, is particularly suitable for shaping the wavefront of a beam with radial symmetry, such as cylindrical beams. It can introduce a controlled phase variation as a function of the radial position, allowing for wavefront manipulation. The linear phase term mθ introduces a constant angular shift to the beam as it propagates. This angular shift can be used to control the direction or steering angle of the beam. By adjusting the value of m, one may change the amount of beam deflection, allowing for precise control over the steering direction. The radial phase term introduces a radial variation in the phase of the beam. This can be utilized to shape the intensity profile of the beam, such as creating focused spots or controlling the beam profile. By appropriately choosing the function l(R), one may achieve specific intensity distributions or tailor the beam shape according to the application requirements.

The index distribution that can create that phase pattern is

n(r)=n₀+(n₁−n₀)l(r)exp(imθ), (109)

where n₀ and n₁ are the refractive indices of the ambient medium and the vortex material, respectively. The refractive index varies as a function of both the radial distance R and the azimuthal angle θ. The terms describe the amplitude of each sinusoidal component with different azimuthal modes, and φm represents the phase offset for each mode. The equation, with its azimuthal symmetry, can be used for beam steering applications. By adjusting the amplitudes and phases of the different azimuthal modes, the direction and intensity profile of the transmitted beam can be controlled, enabling beam steering functionalities.

To describe the refractive index variation in a GRIN spiral phase plate, the following equation may be used:

n(r,θ)=n₀+Σ(m=1,3,5, . . . )aₘ(r/R)^{m} sin(mθ+φm), (110)

where n₀ is the background refractive index, r and θ are the radial and azimuthal coordinates in polar coordinates, R is the radius of the spiral phase plate, aₘ and φₘ are the amplitude and phase of the m-th order spiral term, respectively. This equation describes the refractive index variation in a GRIN spiral phase plate using a Fourier series expansion, where n₀ is the average refractive index, aₘ are the Fourier coefficients that determine the amplitude of the refractive index variation at each harmonic frequency, R is the radius of the spiral, θ is the azimuthal angle, and φₘ is the phase angle for each harmonic component.

The key feature of this expression is the presence of different azimuthal harmonics with odd values of m (1, 3, 5, . . . ). Each term contributes to the overall refractive index distribution, resulting in a specific phase modulation across the beam. The amplitude (aₘ) determines the strength of each harmonic component, while the phase shift (φₘ) determines the offset or rotation of the phase pattern for each harmonic.

The first coefficient a₁ determines the magnitude of the linear phase gradient across the plate and does not affect the optical vortex properties of the plate. The second coefficient a₃ controls the strength of the optical vortex and the direction of rotation of the helical wavefront. The higher order coefficients a₅, a₇, etc. introduce additional spiral components to the phase distribution. The exact values of the aₘ coefficients depend on the design requirements of the spiral phase plate, such as the desired optical vortex charge, the radius of the spiral structure, and the wavelength of the incident light.

The mathematical function that describes the two spiral phase plates, one opposite the other, rotated relative to one another can be written as follows:

ϕ(x,y,θ)=mφ(x,y)−mφ(x cos θ+y sin θ,y cos θ−x sin θ), (111)

where ϕ(x,y, θ) is the combined phase function of the two spiral phase plates at position (x, y) and angle θ, ω(x, y) is the individual phase function of each spiral phase plate, m is the topological charge of the spiral phase plate, and θ is the rotation angle between the two plates.

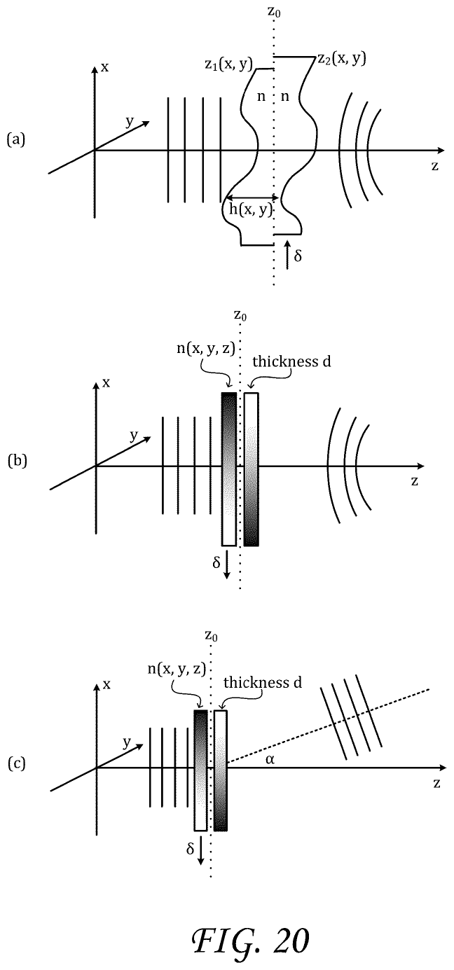

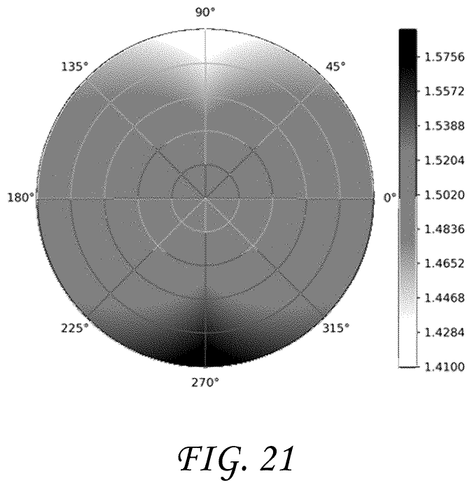

To further illustrate some of the features above, FIG. 20 shows aspects of (a) a surface-figured optical element composed of two conjugate parts designed to provide variable optical power as a function of translation as a result of the combined surface shapes; (b) an example equivalent GRIN optic in two opposing plano-plano parts designed to modulate incident wavefronts to cause variable optical power as a function of translation of the combined GRIN profiles; and (c) an example GRIN optic in two opposing plano-piano parts designed to modulate incident wavefronts to cause deflection of an incident beam as a function of translation of the combined GRIN optical elements.

FIG. 21 shows aspects of a GRIN phase plate optical element with a refractive index distribution that implements a spiral phase function across the device, such that when translated rotationally relative to a complementary GRIN phase plate optical element, the helical phase profile that changes phase with the relative rotation angle, may reverse the handiness of the resulting vortex.

### XI

To summarize, one aspect of this disclosure is directed to a device to variably manipulate electromagnetic waveforms using two freeform elements, which, when translated relative to one another, either laterally or rotationally, result in a variable optical function. The device media have complex dielectric properties that vary throughout the device. In one aspect, the refractive index, permeability, or permittivity may be varied by forming the media with three-dimensional freeform compositional patterns in which the patterns have no axis of symmetry. The compositional material patterns result in complex dielectric functions that change the phase delays of transmitted wavefronts. The combined phased delays of the elements can change the optical functions of the combined elements. The optical functions may include optical power, beam steering, or other wavefront manipulation.

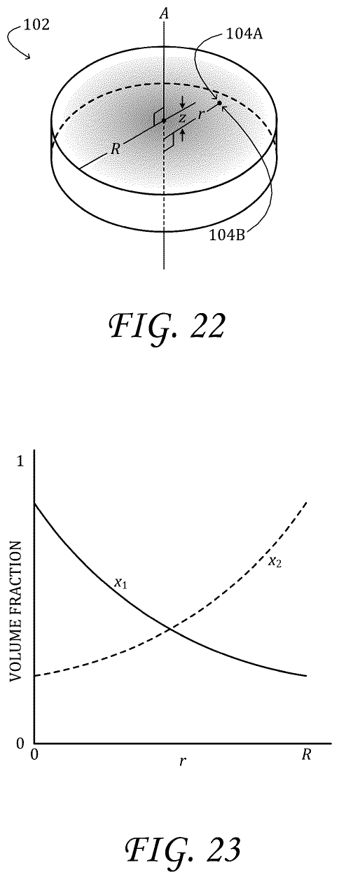

FIG. 22 shows aspects of an example gradient refractive index (GRIN) optic 102. In the illustrated example, optic 102 takes the form of a disc symmetric about optical axis A. Optic 102 comprises first material 104A and second material 104B and optionally may comprise additional materials (vide infra). The first and second materials are distributed inhomogeneously within optic 102. The first material is distributed according to a first volume-fraction profile x₁(r), and the second material is distributed according to a second volume-fraction profile x₂(r). The graph of FIG. 23 shows example first and second volume-fraction profiles, each plotted as a function of a coordinate r. Generally speaking, r is a geometric coordinate of optic 102. In the illustrated example r corresponds to radial distance from axis A. In other examples r may correspond to a different geometric coordinate or to a linear combination of geometric coordinates. In some examples a GRIN optic may have more or less symmetry than optic 102 and a different overall shape.

First material 104A has a first refractive index n₁(λ), and second material 104B has a second refractive index n₂(λ), where λ denotes wavelength. In the examples herein the first refractive index is greater than the second refractive index for λ_{B}<λ<λ_{R}. The difference in the refractive index of the first and second materials is denoted Δn(λ)=n₁(λ)−n₂(λ). To a good approximation, the observed refractive index n in radially symmetric optic 102, at any value of r, is a linear combination of n₁(λ) and n₂(λ) weighted according to the respective volume fractions of the first and second materials at that same r:

n(λ,r)=x₁(r)n₁(λ)+x₂(r)n₂(λ). (112)

For an optic including a third material, etc., the weighted sum is extended accordingly. In combination with n₁(λ) and n₂(λ), the first and second volume-fraction profiles define a gradient in the observed refractive index of the optic. Thus, for a given wavelength λ (or sufficiently narrow range of wavelengths), it is possible to engineer a desired refractive-index gradient by appropriate material selection and control over the first and second volume-fraction profiles x₁(r) and x₂(r).

In optic 102 of FIG. 22, the observed refractive index decreases with increasing distance r from optical axis A, thereby defining a radial component of the refractive-index gradient. In more particular examples, the radial component may be such that the refractive index changes as a function of one or more terms of r^{x}, for example where x≥2. In other examples, the radial component may have a more complex refractive-index distribution. For some radially symmetric optics the radial component may be a superposition of radial components—e.g.,

n(λ,r)=n₀+Δn(a₂r²+a₄r⁴+a₆r⁶+ . . . ), (113)

where coefficients aₓ weight corresponding radial powers r^{x}, and where n₀ is the refractive index at the center of the optic. In some examples the radial component may vary as a function of depth z along the optical axis. The refractive index along z may also vary as a function of one or more terms of z^{x}, for example where x≥2. In the case where the refractive index varies with both r and z, the refractive index at any location may be represented as

n(λ,r,z)=n₀+Δn(a₂r²+a₄r⁴+a₆r⁶+b₁z,b₁z²+a₂b₁r²z+a₂b₂r²z²+ . . . ), (114)

where coefficients bₓ weight corresponding depth powers z^{x}.

Thus, the observed refractive-index may vary in directions perpendicular and/or parallel to the optical axis. GRIN optics having refractive-index profiles of lower symmetry are also envisaged. In particular, an optic consonant with this disclosure may have a refractive index profile with no translational or rotational symmetry about axes normal to a mean plane. An optic consonant with this disclosure may have a surface profile with no translational or rotational symmetry about axes normal to a mean plane. Equally envisaged are freeform optics where the refractive-index gradient is asymmetric about the optical axis, as can be described by more complex polynomial representations. In optic 102, however, optical power derives from the controlled gradient of the observed refractive index in the radial direction, ∂n/∂r. As described hereinafter, one way to exert such control is to form optic 102 from a cured coalescence of ‘ink’ droplets providing the controlled volume fractions of the first and second materials. Such an optic can be engineered to provide optical power—e.g., convergent focus of light rays passing through the optic. In such examples, the refractive-index gradient provides a function analogous to the gradient entry and/or exit surface angles of a conventional spherical lens. Accordingly, optic 102 can be engineered to provide optical power despite having no curvature on the entry or exit faces. Nevertheless, optic 102 optionally may include at least one curved surface for additional optical power. The skilled reader will note that a ‘gradient’ defined as a scalar departs somewhat from standard usage; the direction of the gradient is assumed to be the direction of greatest change unless otherwise stated.

A practical way to realize optical materials with refractive indices amenable to the approach herein is to base each material on a polymer species or mixture of polymer species. A polymer-based material can be deposited in a controlled manner in the form of liquid droplets, which coalesce and subsequently solidify in a desired shape (vide infra). Accordingly, first material 104A and second material 104B of optic 102 (and a third material, etc., in examples in which additional materials are incorporated) may each include at least one polymer species. The term ‘matrix’ refers herein to the at least one polymer species on which a material is based. In examples in which a substantially transparent optic is desired, each polymer species may be an optically transparent polymer species. Suitable polymer species include propylene carbonate (PC), di(ethylene glycol) diacrylate (DEGDA), fluoroethylene glycol diacrylates (FEGDA, FEGDA(2)), neopentyl glycol diacrylate (NPGDA), 2-hydroxyethylmethacrylate (HEMA) and hexanediol diacrylate (HDDA or HDODA) polymers, bisphenol A novolak epoxy (SU8), polyacrylate (PA), polymethyl methacrylate (PMMA), polystyrene, polydiacetylene (PDA), poly(ethylene glycol diacrylate (PEGDA), and poly[(2, 3, 4, 4, 5, 5-hexafluorotetrahydrofuran-2, 3-diyl)(1, 1, 2, 2-tetrafluoroethyl-ene)] (CYTOP)). Other polymer species providing desired physicochemical properties may also be used.

In some examples, one or more nanoparticle species may be dispersed in a matrix in order to modify the wavelength-dependent refractive index of the matrix. Accordingly, first material 104A and/or second material 104B of optic 102 (and/or a third material, etc., in examples in which additional materials are incorporated) may be composite materials of fixed composition. More particularly, each material may include at least one nanoparticle species dispersed in a matrix. The term ‘nanocomposite material’ refers herein to a dispersion of at least one nanoparticle species in a matrix. In examples in which a substantially non-scattering optic is desired, an average nanoparticle size may be selected for each nanoparticle species such that the size is too small to effect significant Rayleigh or Mie scattering in optic 102. Accordingly, the selected average size may depend on the wavelength band of interest. For non-scattering optics engineered for the visible wavelengths, the selected average size may be less than 50 nanometers (nm), for example. Further, the coefficient of extinction, combining absorbance and reflection, of a nanocomposite material may be 10% or lower, preferably 1% or lower, over the band of interest.

Nanoparticle species suitable for modifying the refractive index of a matrix include various metal, metal oxide, chalcogenide, and semiconductor nanoparticles. More particular examples include zinc sulfide (ZnS), zirconium dioxide (ZrO₂), barium titanate (BTO), bismuth germanate (BGO), nano-diamond (NanoD), zinc oxide (ZnO), beryllium oxide (BeO), magnesium oxide (MgO), aluminum nitride (AlN), wurtzite AlN (w-AlN), titanium dioxide (TiO₂), tellurium dioxide (TeO₂), aluminum oxide imide (Al₂O₃HN), molybdenum trioxide (MoO₃), aluminum-doped ZnO (AZO), germanium-doped silicon (SiGe), silicon dioxide (SiO₂), and lithium fluoride (LiF) nanoparticles, hollow SiO₂ nanospheres (h-SiO₂), and shelled variants of any of the foregoing nanoparticles supporting ZrO₂, MgO, SiO₂, ZnO, or other shells, including those that cause the nanoparticles to be more or less reactive with the matrix. Other nanoparticle species providing desired physicochemical properties may also be used. For some nanoparticle species, nanoparticle stability and/or dispersability in a matrix can be enhanced by chemical modification of the surface of each nanoparticle. For instance, the nanoparticles may be surface-functionalized by a suitable ligand—e.g., acrylic acid, phosphonic acid, or a silane—that provides chemical compatibility dispersability with the matrix, thereby enhancing optical clarity. Ligands may be selected to covalently bond to the surface of the nanocrystal via an ‘anchor’ moiety and/or repel each other via a ‘buoy’ moiety, thereby discouraging aggregation. In some examples, a distal site on a ligand may bond covalently to a monomer of the matrix so that dispersability is maintained during polymerization.

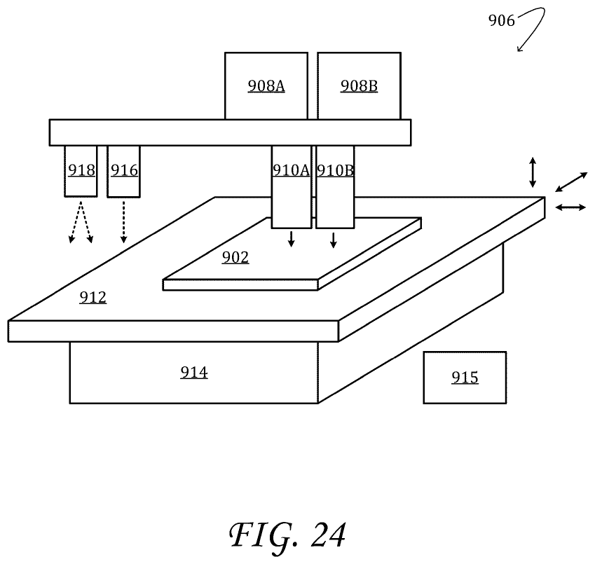

FIG. 24 shows aspects of a non-limiting example apparatus configured for additive manufacture of an article. Additional details are found in U.S. patent application Ser. No. 16/224,512 entitled NANOCOMPOSITE OPTICAL-DEVICE WITH INTEGRATED CONDUCTIVE PATHS and Ser. No. 16/507,658 entitled PRINTED CIRCUIT BOARD WITH INTEGRATED OPTICAL WAVEGUIDES; FUNCTIONALLY GRADED POLYMER MATRIX NON-COMPOSITES BY SOLID FREEFORM FABRICATION, Solid Freeform (SFF) Symposium (2003); and POLYMER MATRIX NANOCOMPOSITES BY INK-JET PRINTING, Solid Freeform (SFF) Symposium (2005), which are hereby incorporated herein by reference for all purposes. Nevertheless, various other deposition methods and apparatuses are also applicable to the approach herein.

Apparatus 906 of FIG. 24 includes reservoir 908A holding a first ink and reservoir 908B holding a second ink. The first ink is a liquid precursor of first material 104A, in which the one or more polymer species takes resinous form, is not cured and/or not cross-linked. Likewise the second ink is a liquid precursor of second material 104B, in which the one or more polymer species takes resinous form, is not cured and/or not cross-linked. Reservoirs 908A and 908B are coupled fluidically to print heads 910A and 910B, respectively. Each print head is configured to discharge the corresponding ink with high spatial accuracy onto optic 902, arranged on platen 912. More particularly, each print head is configured to add individual voxels of ink to the optic. In examples in which a third, etc., material is used, the apparatus may include a separate reservoir and print head for additional, corresponding inks. In these and other examples, both the order of deposition of the ink droplets and the location of each droplet may be controlled to high precision.

Platen 912 is coupled mechanically to translational stage 914. The translational stage is configured to adjust the displacement of the platen along each of the three Cartesian axes. In other examples, displacement along any, some, or all of the Cartesian axes may be adjusted by movement of the print heads instead of, or in addition to, the platen. In still other examples, a translational stage may adjust the relative displacement of the platen and print heads along two Cartesian axes, and a rotational stage (not shown in the drawings) may be used to adjust the azimuth of voxel deposition in the plane orthogonal to the two Cartesian axes. In every case, the adjustment is controlled (e.g., servomechanically), pursuant to control signals from controller 915. More particularly, the controller may be configured to transmit, to the translational stage and to the first and second print heads, signal defining the first and second volume-fraction profiles, for each of a plurality of voxel-thick layers of the optic. The controller may compute these patterns by parsing a 3D digital model of the optic to be fabricated and returning the intersection of the 3D digital model with a series of cutting planes corresponding to the plurality of layers.

Continuing in FIG. 24, apparatus 906 includes a directed optical emitter 916 and a diffuse optical emitter 918. The optical emitters may comprise lasers or lamps of any emission profile suitable for curing the inks. The displacement of the optical emitters relative to platen 912 may be controlled in the same manner as the displacement of the print heads relative to the platen. The directed optical emitter may be used for selective, localized curing of certain regions of voxels, and the diffuse optical emitter may be used to cure larger regions of the optic. In examples in which one of the inks is thermally curable, a heat emitter may be included.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

It will be understood that the configurations and/or approaches described herein are exemplary in nature, and that these specific examples are not to be considered in a limiting sense, because numerous variations are possible. The specific routines or methods described herein may represent one or more of any number of processing strategies. As such, various acts illustrated and/or described may be conducted in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An optic configured for variable wavefront shaping of electromagnetic radiation, the optic comprising:
a first optical element including a solidified heterogeneous coalescence of nanocomposite material providing a first complex dielectric-function gradient;
a second optical element including solidified heterogeneous coalescence of nanocomposite material providing a second complex dielectric-function gradient,
wherein the first and second optical elements are arranged in tandem along an optical axis and together provide wavefront shaping that varies in dependence on a displacement of the first optical element relative to the second optical element.

2. The optic of claim 1 wherein the first and/or second complex dielectric-function gradient is a freeform gradient, a non-radially symmetric gradient, a non-axially symmetric gradient, or an anamorphic gradient.

3. The optic of claim 1 wherein the first or second complex dielectric-function varies radially and axially, relative to the optical axis.

4. The optic of claim 1 wherein the first and/or second complex dielectric-function gradient is modified by laser radiation.

5. The optic of claim 1 wherein the displacement changes a focal length of the optic.

6. The optic of claim 1 wherein the displacement changes a direction of a beam exiting the second optical element relative to the direction of the beam entering the first optical element.

7. The optic of claim 1 wherein the displacement imparts an effect of a variable wedge function on the electromagnetic radiation.

8. The optic of claim 1 wherein the displacement reproduces an effect of a variable phase plate on the electromagnetic radiation.

9. The optic of claim 1 wherein the displacement reproduces an effect of a variable blazed grating on the electromagnetic radiation.

10. The optic of claim 1 wherein the electromagnetic radiation comprises near-infrared, infrared, millimeter-wave, or radio-frequency radiation.

11. The optic of claim 1 wherein the optic is arranged in a vision-correcting device, optical scanner, variable-magnification telescope, or variable-magnification microscope.

12. The optic of claim 1 wherein the first and second optical elements are configured for time varying spatial radiance.

13. The optic of claim 1 wherein the optic is arranged in an antenna.

14. The optic of claim 1 wherein dispersive properties of the nanocomposite materials of the first and second optical elements impart a wavelength dependence to the variable wavefront shaping.

15. The optic of claim 1 further comprising an anti-reflective coating arranged on the first and/or second optical element.

16. The optic of claim 1 further comprising a beam deflector configured to extract optical power from the optic.

17. The optic of claim 1 wherein the first and/or second complex dielectric-function gradient comprises a Fresnel implementation of a complex dielectric-function gradient.

18. The optic of claim 1 wherein the first and/or second complex dielectric-function gradient comprises a segmented freeform implementation of a complex dielectric-function gradient.

19. The optic of claim 1 wherein the optic is configured to emit a light field or hologram.

20. The optic of claim 1 further comprising at least one opaque baffle arranged between the first and second optical elements.

21. The optic of claim 1 further configured to transmit the electromagnetic radiation only through an area of overlap between the first and second optical elements.

22. The optic of claim 1 wherein the first and second optical elements are arranged in an array of analogously configured optical elements, and wherein the complex dielectric-function gradient varies in dependence on a position of each optical element in the array.

23. A system of optics configured for variable focus, the system comprising:
a first optic including first and second gradient complex dielectric-function optical elements arranged in tandem along an optical axis, which together provide an optical power that varies according to a displacement of the first optical element relative to the second optical element; and
a second optic including third and fourth gradient complex dielectric-function optical elements arranged in tandem along an optical axis, which together provide an optical power that varies according to a displacement of the third optical element relative to the fourth optical element,
wherein focal lengths of the first and second optics are adjustable relative to each other.

24. The system of claim 23 further comprising at least one additional lens element arranged between the first and second optics.

25. The system of claim 23 wherein dispersive properties of the first and second optics are matched to achieve achromatic performance.

26. A method of manufacture of a nanocomposite ink-based optic with a complex dielectric-function gradient and variable focus, the method comprising:
having or providing a nanocomposite-ink printing apparatus with a nanocomposite ink including an organic matrix with a nanoparticle dispersed within the organic matrix;
depositing and forming a first optical element having a first surface and a second surface with a gradient optical index therebetween;
depositing and forming a second optical element having a third surface and a fourth surface with a gradient optical index therebetween, the first optical element and the second optical element each comprising a cured nanocomposite ink with an organic matrix and a nanoparticle dispersed within the organic matrix,
wherein the first and the second optical elements are arranged in tandem along on an optical axis and have an optical power that varies according to a translation between the first and second optical elements.

27. The method of claim 26 further comprising depositing and forming a third optical element configured to co-locate an optical axis of the first optical element to an optical axis of the second optical element over an operating range of the translation.

28. The method of claim 26, wherein the nanocomposite ink of the first optical element and the nanocomposite ink of the second optical element are selected such that a slope of refractive index with respect to wavelength of a highest average refractive index nanocomposite ink and slope with respect to wavelength of a lowest average refractive index ink are parallel to 1% or better.
